(19) United States
(12) Patent Application Publication
(10) Pub. No.: US 2025/0372936 A1
(43) Pub. Date: Dec. 4, 2025

(54) SYSTEMS AND METHODS FOR GENERATING SUPER-POLARIZED ELECTROMAGNETIC RADIATION

(71) Applicants: Stuart Mirell, Los Angeles, CA (US); Daniel Mirell, Irvine, CA (US)

(72) Inventors: Stuart Mirell, Los Angeles, CA (US); Daniel Mirell, Irvine, CA (US)

(21) Appl. No.: 18/732,565

(22) Filed: Jun. 3, 2024

(51) Int. Cl. H01S 3/08031; G02B 27/28; H01S 3/00

(52) U.S. Cl. CPC H01S 3/08031; G02B 27/283; G02B 27/286; H01S 3/0085

(57) ABSTRACT

There are disclosed systems for generating super-polarized electromagnetic radiation comprising a source providing a source beam of electromagnetic radiation, a beam splitter having a selected transmission-reflection coefficient ratio, a rotator that provides equivalence to an orthogonal rotation of modes, a two-channel polarizer having polarization axes orthogonal to each other, and a means for directing the two beams from the beam splitter to the corresponding inputs of the two-channel polarizer, wherein the first beam polarization axis is in axial alignment with the first input polarization axis of the two-channel polarizer and orthogonal to the second input polarization axis of the polarizer, wherein the rotator is positioned in the second beam to provide equivalence to an orthogonal rotation of modes on the second beam, wherein the paths traveled by the first beam the second beam are equal, and wherein the output beams combine to form an output beam including super-polarized modes.

### BACKGROUND OF THE INVENTION

The present disclosure relates to systems for generating super-polarized electromagnetic radiation. Most commonly, electromagnetic radiation is generated as unpolarized. Because of a variety of polarization-dependent interactions that occur with various substances and compositions of matter, the use of linearly polarized radiation is essential for particular applications in communications, imaging, and many other areas of technology. The utility of linearly polarized radiation is further enhanced when that radiation is coherent. For example, in the optical range of the electromagnetic spectrum, lasers, which generate coherent beams of electromagnetic radiation, are often additionally equipped to generate those beams as linearly polarized.

Similarly, in other ranges of the electromagnetic spectrum, such as microwaves, radiation that is polarized provides enhanced utility relative to non-polarized radiation because of a variety of well-known polarization-dependent interactions that radiation has with matter.

In general, polarization-dependent interactions are of significance because they maximally provide a differential polarization effect when the radiation's polarization axis has some particular orientation compared to an orientation orthogonal to that particular orientation. Angular deviations from that particular orientation and its orthogonal dilute the differential polarization effect because of Malus's Law. According to Malus's Law, the transmitted irradiance (energy flux density) of a linearly polarized beam through a simple polarizer functionally varies as cosine squared. For example if the beam is identified as linearly polarized at 0°, the irradiance transmission is given by cos² θ where θ is the angular position of the polarizer's polarization axis.

Consequently, a desirable differential polarization effect for a linearly polarized beam is maximized for orientations θ=0° and the orthogonal θ=90° since the respective transmitted irradiances are in a ratio of 1:0. However, if uncontrollable deviations from these alignments are present, the differential polarization effect is degraded. For example, at a 30° deviation the maximum and minimum irradiances from Malus's Law are in a ratio 0.75:0.25, respectively.

In general, polarization effects utilized to advantage by employing polarized beams are inherently degraded by the misalignment sensitivity that arises from Malus's Law. That sensitivity would be markedly reduced if a radiation beam could, for example, circumvent Malus's Law and be “super-polarized” such that the beam's irradiance through a common linear polarizer would be totally transmitted over an entire 90° rotation of that polarizer and totally blocked over a further 90° rotation. The present disclosure includes systems and methods for generating such super-polarized beams, as well as descriptions of certain applications of the produces beams.

### SUMMARY OF THE INVENTION

The underlying basis for Malus's Law can be understood from the property that each of the photon wave packets in a linearly polarized beam spans a 90° arc in the plane transverse to the propagation direction, but the orientations of individual wave packet arcs, as defined by their respective arc bisector orientations, are not identical. Collectively, those orientations are statistically represented by a particular distribution in a locally real representation as described in references Reference 1,¹ and Reference 2,² which are hereby incorporated by reference in their entireties. ¹ S. Mirell. Correlated Photon Asymmetry in Local Realism. Physical Rev. A. vol. 50. No. 1. pp. 839-842. July 1994.² S. Mirell. Locally real states of photons and particles, Physical Rev. A. vol. 65 p. 032102/1-22. Jan. 30, 2002.

In that representation of photon wave packets, an incident photon is transmitted by a polarizer, with its axis oriented at some angle θ, only if that photon's wave packet arc happens to intersect that polarizer axis. From the particular distribution of wave packet orientations for photons linearly polarized for example at 0°, a cos² θ fraction of the photons satisfies that intersection requirement thereby elucidating the underlying basis of the observationally-based Malus's Law.

The present disclosure includes a means for circumventing Malus's Law by reorienting the wave packet arc of each individual photon of the linearly polarized beam from some random θ′ of the orientation distribution to some selected θ″ that is independent of the original particular θ′ value. This provides an output beam of individual photons that are all oriented at that selected θ″ and are said to be “super-polarized.” A super-polarized beam does not conform to Malus's Law.

The utility of the systems and methods of the present disclosure are increased by the deduction that linearly polarized photons have relevant functional analogs with respect to linearly polarized coherent modes of electromagnetic radiation. For example, in the optical range, a linearly polarized single longitudinal mode (SLM) laser emits, in temporal succession, linearly polarized coherent beam segments of photons. Each such beam segment is commonly identified as a “coherence length” since these successive beam segments are not mutually coherent, i.e., they have a random phase relation with each other. For a linearly polarized SLM laser, the coherence length might be on the order of 100 meters and comprises an extremely large number of mutually coherent photons that are identical in wavelength and, importantly, that are identical in orientation.

Because of structural and functional similarities of single-photon wave packets and SLM coherence lengths, both are substantially applicable to the systems and methods of the present disclosure. The orientation for any given single-photon wave packet or SLM coherence length is some random θ′ and has the same orientation distribution associated with linearly polarized photons. Over time, as a large number of these single-photon wave packets or SLM coherence lengths are sequentially emitted, the various random θ′ orientations collectively have the same distribution as that of a linearly polarized beam of photons.

The systems and methods of the present disclosure can be applied to a linearly polarized SLM beam thereby facilitating the production of a super-polarized coherent beam. The resultant sequentially emitted modes of the SLM beam all have a selected identical orientation. Accordingly, the systems and methods of the present disclosure are generally applicable to a beam of single longitudinal modes where those modes are single-photon wave packet modes as well as to single coherent modes.

The capability of producing a super-polarized beam provides further utility for the systems and methods of the present disclosure with regard to facilitating very efficient methods for generating high intensity “duality modulated” beams, as disclosed in U.S. Pat. No. 11,681,084, which is hereby incorporated by reference in its entirety. These duality modulated beams include totally depleted “empty” wave beams that are devoid of energy quanta and are undetectable by conventional means as well as highly enriched beams that have a greatly increased energy quanta density relative to the wave intensity of the beams on which the quanta reside.

The super-polarized output generated by the systems and methods of the present disclosure provides enhanced utility for a variety of applications. In some embodiments, the super polarizer in combination with a linear polarizer constitutes a single stage of a super polarizer duality modulator. That linear polarizer can be a two-channel polarizer that provides two outputs. Optimally, that single-stage super polarizer duality modulator can exceed the enrichment of a single stage by nearly an order of magnitude and can exceed the empty wave intensity of a single stage by nearly a factor of five. These advantages for “single stages” of a super polarizer duality modulator relative to are markedly further enhanced by cascading their respective single stages.

In some implementations, the methods of the present disclosure may enable the use of a small-intensity “signal” beam to digitally control a high intensity “source” beam. This digital control provides for abrupt transmission or blockage of the source beam's particle-like property of irradiance.

This control of source beam irradiance occurs even if the signal beam itself is totally depleted. As a consequence, a related variant of this irradiance control method provides for a new method of demodulating information on a received small intensity, totally depleted beam by applying that signal beam to control a high intensity irradiance-bearing beam compared to demodulation methods disclosed in prior patents of the inventors, as disclosed in U.S. Pat. Nos. 7,262,914; 8,081,383; 8,670,181; and 11,681,084, which are hereby incorporated by reference in their entireties.

### BRIEF DESCRIPTION OF THE DRAWINGS

FIG. 1A is a perspective 3-D view of amplitude on a representative two-wavelength segment of a linearly polarized wave packet structure with transverse arc bisector orientation −40° which is equivalently the complementary orientation 140°. The view applies to the linearly polarized wave structure of a single-photon mode as well as to the linearly polarized wave structure of a single longitudinal mode (SLM) coherence length.

FIG. 1B depicts an instantaneous transverse cross-sectional 2-D view of a wave packet structure, analogous to that of FIG. 1A, at some point along its length. However, in the depicted example of this figure, the bisector of the wave structure's wave packet arc is oriented at +30° from a vertical axis in the transverse plane. The dotted line depicts the corresponding transverse view at a different point, a half-wavelength more distant along the length of the wave packet, showing a wave packet arc oriented at the complementary angle ±210°.

FIG. 2A depicts the arc bisector orientations and distribution frequency for members of a polarization ensemble shown here for a 0°-centered ensemble. The finite 16-member ensemble is a moderately accurate representation of an infinite-member ensemble. The members (rows) are statistically representative of linearly polarized wave packets. Each member has a 90° arc span.

FIG. 2B depicts the super polarization of the FIG. 2A ensemble in which the orientation of all members is at a common, selected angle ϕ in the transverse plane.

FIG. 3 is a cross-sectional view of a “split amplitude” super polarizer configuration at the level of the co-planar beam paths showing a beam splitter, a beam rotator inserted in one path, a calcite two-channel polarizer and individually identified physically distinct beam path segments.

FIG. 4A is a vector diagram representing the transverse wave amplitude at one physically distinct beam of the numerically identified path segment “i” of the FIG. 3 configuration.

FIG. 4B is a vector diagram representing the transverse wave amplitude at a different physically distinct beam of the numerically identified path segment “i” of the FIG. 3 configuration.

FIG. 4C is a vector diagram representing the transverse wave amplitude at a different physically distinct beam of the numerically identified path segment “i” of the FIG. 3 configuration.

FIG. 4D is a vector diagram representing the transverse wave amplitude at a different physically distinct beam of the numerically identified path segment “i” of the FIG. 3 configuration.

FIG. 4E is a vector diagram representing the transverse wave amplitude at a different physically distinct beam of the numerically identified path segment “i” of the FIG. 3 configuration.

FIG. 4F is a vector diagram representing the transverse wave amplitude at a different physically distinct beam of the numerically identified path segment “i” of the FIG. 3 configuration.

FIG. 4G is a vector diagram representing the transverse wave amplitude at a different physically distinct beam of the numerically identified path segment “i” of the FIG. 3 configuration.

FIG. 5 is a cross-sectional view of a super polarizer configuration closely analogous to that of FIG. 3 but employing instead a polarizing beam splitter in place of a calcite polarizer.

FIG. 6A is a perspective view of a “polarizer-retarder” super polarizer with input and output beams depicted. The super polarizer is comprised of a linear polarizer and a retarder in contiguous juxtaposition. With regard to phase-type, the retarder is optimally full wave but may also be half wave or any multiple thereof.

FIG. 6B is a cross sectional view of the FIG. 6A polarizer-retarder super polarizer at the level of the beams identifying the internal beam segment paths along with the input and output beam paths exaggerated along the propagation path for visual clarity.

FIG. 6C is a plane view of the beam-incident faces of the polarizer and the retarder where an optimum relative orientation of the single polarization axis of the polarizer is shown equiangular from the fast and slow axes of the retarder.

FIG. 7A is a cross sectional view of a calcite polarizer at the level of the co-planar beams. The configuration provides orthogonally polarized output beams from projections of an input beam.

FIG. 7B shows a “composite super polarizer duality modulation stage” comprising a super polarizer, a half wave plate and a calcite polarizer respectively aligned to optimally provide a totally depleted output and an enriched output.

FIG. 7C depicts a “composite (super polarizer) duality modulation configuration,” functionally equivalent to the FIG. 7B configuration but using a polarizing beam splitter in place of a calcite polarizer.

FIG. 8A depicts a cascade of three stages of the FIG. 7A configurations that provides a modest performance improvement relative to that of a single stage.

FIG. 8B illustrates a block diagram of three composite (super polarizer) duality modulation stages in a cascade configuration where each stage is individually depicted as a separate block. The cascade configuration produces a single final increased enrichment output beam and three totally depleted output beams.

FIG. 9 depicts a “super polarizer switch” comprising a super polarizer such as that given in FIG. 5 and further including a half wave plate, a second polarizing beam splitter, a linear polarizer and a conventional energy-sensitive detector. The linear polarizer blocks the output of the super polarizer from reaching the detector unless an empty wave beam is concurrently present at an input of the second beam splitter to marginally rotate that output orientation to transmission through the linear polarizer.

### DETAILED DESCRIPTION OF THE INVENTION

The present disclosure is directed to systems and methods for super-polarization of linearly polarized photons. In some embodiments, a single-photon source provides a directed beam comprised of a sequence of linearly polarized photons in which each photon wave packet constitutes a single mode. In some embodiments, the linearly polarized photons may comprise nearly identical wavelengths. For example, such sources in the optical range might provide approximately 10⁵ or more photons per second. The linear polarization orientation orthogonal to the beam axis may be designated as the vertical axis at 0°.

In addition to single-photon wave packet modes, the methods disclosed here are also applicable to coherent beams of single longitudinal mode electromagnetic radiation beams. For example, in the optical range of the electromagnetic spectrum, the methods are applicable to the coherent beam emitted by a linearly polarized single longitudinal mode (SLM) laser. The methods may be applicable to beams in other ranges of the electromagnetic spectrum when the beam source is produces an SLM beam. In some embodiments, successive coherence lengths of a linearly polarized SLM source may constitute a mode at a random polarization ensemble member orientation. Systems disclosed herein may reorient the beam to a selected orientation.

For a conventional source beam comprised of linearly polarized electromagnetic radiation, a linear polarizer inserted into the beam path would yield an average transmitted irradiance proportional to cos² θ where θ is the angle of polarizer's axis relative to the beam's polarization axis. The functional relationship of the transmitted irradiance relative to the polarizer orientation is a demonstration of Malus's law for a conventional polarized source. However, if that source beam is super-polarized before reaching the linear polarizer the resultant transmission through that polarizer is very different. If a linear polarizer is inserted in the path of a beam of super-polarized modes, the output of the polarizer is a uniform irradiance over a 90° rotation of the polarizer followed by a zero irradiance over the successive 90° rotation of the polarizer.

FIG. 1A shows a diagram of a two-wavelength section of a linearly polarized electromagnetic wave. That view could represent a section of a discrete photon wave packet mode or could alternatively represent a section of an SLM wave mode, e.g. in the optical range, from a laser. In either case, the depicted segment longitudinally shows only a very small representative fraction of the entire wave structure. A notable characteristic of this wave structure is that a cross-section transverse to the longitudinal wave structure is a 90° “pie-sector” arc of that structure. This cross-section is depicted in FIG. 1B. A radial vector at the arc bisector defines the transverse orientation θ of the arc shown here with respect to the +V axis which is assigned to be at 0°. A cross-section at a half-wavelength displacement along the wave structure would yield a similar but reflected (dotted line) arc at θ+180° arising from the sinusoidal longitudinal oscillation of the wave structure. The radial amplitude is maximal at the half-wavelength peaks of the wave structure. Because of the wave structure's transverse bi-directionality, it is sufficient to define the orientation of the wave structure from the arc bisector orientation θ in the two quadrants adjacent to the +V axis at 0°.

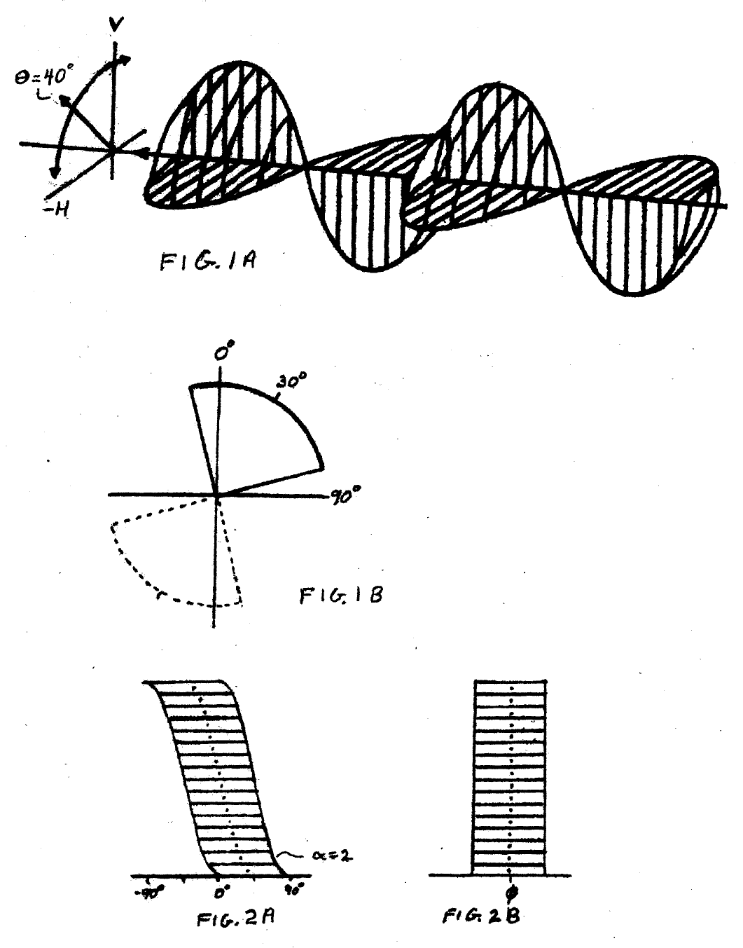

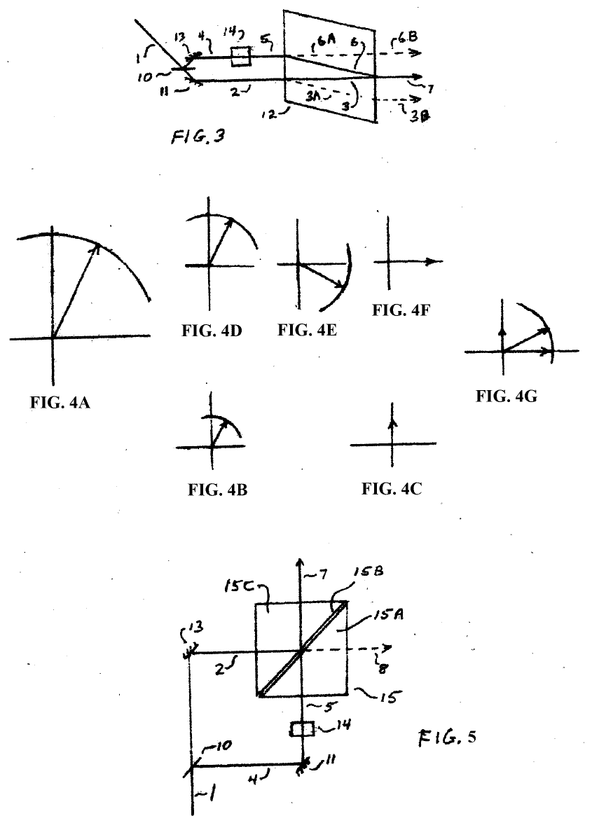

The transverse distribution of wave packet mode orientations for linearly polarized single-photons are graphically represented by the FIG. 2A ensemble. For linear polarization along the vertical axis at 0°, the horizontal rows depict a statistically representative 16-member ensemble of wave packet orientations relative to that axis. The dots at the center of each row identify the bisector orientation of that ensemble member. For example, the FIG. 1B wave packet oriented at 30° has an arc spanning −15° to +75°. That particular wave packet mode is representative of the α=2 member in the FIG. 2A ensemble. A polarizer analyzer axis oriented at an angle incrementally greater than 75° will intersect (and “transmit”) only the first ensemble member (α=1), constituting 1/16=0.063 of the total 16 members in approximate agreement with Malus's Law that predicts a cos² 75°=0.067 transmission fraction.

That 16-member ensemble provides a substantially accurate distribution of actual wave packet orientations despite the ensemble's small finite sampling. The actual distribution is achieved in the limit as the number of ensemble members goes to infinity and exact agreement with the curvilinear cosine squared envelope is realized. In some embodiments, for purpose of compactly and clearly representing the functional aspects, finite ensembles may be employed.

The transverse representation of wave packets in FIG. 2A depicts an ensemble that, by example, is chosen to be centered at 0°. Wave packet modes statistically represented by that ensemble would be identified as “0°-polarized” or equivalently “vertically polarized” where the vertical axis is defined as 0°. Similarly, a similar ensemble centered at some arbitrary angle θ would be identified as “θ-polarized”.

More generally, it may be readily appreciated that the fraction of ensemble members intersected and transmitted by a polarizer analyzer with its axis at any angle on the FIG. 2A 0°-polarized distribution is given by the cosine square of that angle whether the angle is in the 0° to +90° or the 0 to −90° range. Accordingly, the FIG. 2A ensemble distribution is physically consistent with Malus's Law.

### Representation of Super-Polarized Waves

The embodiment shown in FIG. 2B, the system may rotate substantially all of the wave packet orientations of a conventional polarization ensemble to a selected orientation ϕ. Those FIG. 2B wave packets are appropriately designated as ϕ—“super-polarized” wave packet modes in contrast to FIG. 2A, which represents the characteristic orientation distribution of wave packet modes that are commonly said to be polarized.

The graphical representations depicted in FIGS. 1A and 1n FIG. 1B can be expressed in terms of the wave function or amplitude Φ(θ) that mathematically represents the depicted structures. In the context of that wave function, θ denotes the arc bisector, −45° for FIG. 1A and +30° for FIG. 1B. A cross-section taken at a wave structure longitudinal maximum provides an arc at a radial distance that represents the modulus or magnitude |Φ(θ)| of Φ(θ). The amplitude Φ(θ) may be represented in boldface text to show it represents a vector quantity. The objectively real representation of Φ(θ) may constitute an infinite set of equal-magnitude radial vectors uniformly distributed over the 90° arc span in the transverse plane and the set representation may be indicated by the underline on the amplitude Φ. An infinite set of equal-magnitude radial vectors uniformly distributed over an arc span is identified here as a “pie-vector”. However, a single-vector Φ(θ) “equivalency” vector amplitude more conveniently substitutes for the Φ(θ) pie-vector amplitude with regard to calculations in the present disclosure.

Accordingly, an equivalency vector amplitude Φ(θ) may be used in place of the pie-vector amplitude Φ(θ) and represents:

$${Φ}_{i} ( θ ) = ξ {M}_{i} r ( θ ) .$$

The subscript “i” appended to an amplitude Φ, or any other quantity, is replaced with a numeral that identifies the value of that quantity specific to a correspondingly numbered path segment.

The factor ξ represents the standard quantum mechanical longitudinal wave function. However, ξ is not substantially participatory in the transverse wave structure manipulations. Accordingly, for the purposes of this disclosure, the modulus of ξ is set to unity, i.e. |ξ|=1.

The arc bisector orientation of θ is specified by the equivalency wave function's single unit radial vector r(θ). As such, r(θ) may be understood to represent the pie-vector quantity r(θ), but this representation may be suppressed for purposes of mathematical expediency when an equivalency vector amplitude Φ(θ) substitutes for the actual pie-vector amplitude Φ(θ).

The radial vector of Φᵢ(θ) at θ represents the bisector orientation of an objectively real 90° wave packet arc. The arcs are not relevant to wave amplitude calculations but the intersection of those arcs with a polarizer axis are determinant of the transfer of energy quanta and can be assessed from the bisector orientation θ.

The unit moduli of ξ and r(θ) facilitate tracking the transverse manipulations of amplitude entirely with the separate magnitude coefficient M since |Φᵢ(θ)|=Mᵢ.

For the purposes of compactly confining wave function parameters to those directly relevant to the present disclosure, coordinates and amplitude phase information along the propagation axis may be suppressed on ξ as well as on Φᵢ(θ). Phase is relevant when two wave structures intersect. In some embodiments, respective path lengths for intersecting wave structures are controlled to maintain “in-phase” conditions unless other explicitly identified phase conditions are specified in the various depicted apparatus configurations.

### Methods for Super Polarization

From the foregoing, two closely related methods of super polarization (SP) are deduced: Method 1—“split amplitude” SP and Method 2—“polarizer-retarder SP”.

### Split Amplitude Super Polarizer

The foregoing representation of the wave function amplitude, together with basic rules of wave interactions with polarizers, are shown in an embodiment of the present disclosure in FIG. 3. It will be appreciated from the synthesis that this particular basic embodiment is appropriately identified as a “split amplitude super polarizer.” The synthesis applies to linearly polarized single-photons as well as to the coherence lengths of linearly polarized single longitudinal modes of an SLM source.

An input mode represented by the amplitude Φ₁(0°_{α})₊ is present on path 1 of the FIG. 3 configuration where |Φ₁(0°_{α})₊|=M₁=1. The amplitude representing an input mode on path 1 is linearly polarized along the 0° vertical axis (normal to the figure plane). Accordingly, Φ₀(0°_{α})₊=ξM₁r(0°_{α})₊=ξr(0°_{α})₊ is transversely represented by a random member _{α} of the 0°-ensemble that is objectively oriented at some angle θ=0°_{α} which for a FIG. 2A infinite member ensemble would range from −45° to +45° with a frequency distribution determined by the cosine squared curvilinear envelope. The presence of an energy quantum on a single-photon wave packet mode or of a multiplicity of energy quanta on a coherent mode as in an SLM laser is denoted by an appended subscript “+”.

In some embodiments, a successive input mode, represented by an amplitude Φ₁(0°_{α})₊, has a realized random member α orientation that is uncorrelated to the realized random member α orientation of the temporally separated preceding wave packet mode. This property is noted here because, in the course of this disclosure, there arise circumstances in which two or more simultaneously present amplitudes having random orientations interact with each other. For these simultaneously present amplitudes, the convention applied in this disclosure is that the amplitudes have mutually non-correlated random orientations when their Greek letter indices are respectively different and have mutually correlated random orientations when those indices are respectively the same.

FIGS. 4A-G depicts multiple vector diagrams, each associated with the amplitude on a respective i-th numerical beam path of FIG. 3, respectively. For example, the FIG. 4A vector diagram depicts the FIG. 3 path 1 amplitude Φ₁(0°_{α})₊. In this depicted example of a randomly selected α, the magnitude M₁=1 of the amplitude vector Φ₁ is oriented approximately at +30° which for the FIG. 2A 16-member 0°-polarized ensemble closely corresponds to α=2.

Φ is objectively a wave representation and the objective presence or absence of energy quanta does not alter the wave function itself in contradistinction to wave functions that are consistent with the Principle of Quantum Duality, as disclosed in U.S. Pat. Nos. 7,262,914 and 11,681,084, which are hereby incorporated by reference in their entireties.

Φ₁(0°_{α})₊ propagating on path 1 is incident on a beam splitter 10 with an amplitude transmission coefficient t and an amplitude reflection coefficient r where t²+r²=1. Note that the amplitude reflection coefficient r is distinguished from the transverse orientation vector of a wave packet represented in boldface as r. Beam splitter 10 induces a transition in that incident Φ₁(0°_{α})₊. As a result, the output paths from beam splitter 10 are numerically differentiated from the input path 1. Specifically, the transmission output path of beam splitter 10 is identified as 2 and the transmitted wave function is:

$${{Φ}_{2} ( {0}_{a}^{◦} )}_{+} = ξ {tr ( {0}_{a}^{◦} )}_{+} = ξ {M}_{2} {r ( {0}_{a}^{◦} )}_{+}$$

that represents a magnitude M₂=t while retaining an orientation 0°_{α} unchanged relative to that of the incident, input Φ₁(0°_{α})₊. The FIG. 4B path 2 vector diagram depicts these values.

Φ₂(0°_{α})₊ continues on path 2 to mirror 11, which alters the wave's propagation direction but does not result in a transition that would alter the wave function formulation. Consequently, beam path 2 is maintained beyond mirror 11 up to an input face of a calcite two-channel polarizer 12.

When Φ₂(0°_{α})₊ is incident on calcite 12, its magnitude M₂ vector amplitude is projected onto the vertical and the horizontal polarization axes of calcite 12. The vertical polarization axis of calcite 12 is perpendicular to the plane of FIG. 3 as is the polarization axis of the 0°-ensemble of which Φ₁(0°_{α})₊ and Φ₂(0°_{α})₊ are a members. As a result, the wave packet arc of Φ₂(0°_{α})₊, depicted in the FIG. 4B vector diagram, intersects the calcite 12 vertical polarization axis.

In some embodiments, the process of a wave packet arc intersecting a polarizer axis may result in energy quanta residing on the arc to be confined to the intersected polarizer axis as the wave packet projections condense onto that polarizer axis.

In the present example of Φ₂(0°_{α})₊, the energy quanta indicated by “+” are transferred to an amplitude on path 3A that lies along the vertical polarization plane of calcite 12. The projection process itself results in a cos (0°_{α}) component of the Φ₂ vector being projected onto that path 3 amplitude. The wave function representation on path 3 is:

$${{Φ}_{δ 3} ( 0 ° )}_{+} = ξ t cos ( 0 {°}_{α} ) {{r}_{δ} ( 0 ° )}_{+} = ξ {M}_{3} {{r}_{δ} ( {0}^{∘} )}_{+}$$

where M₃=t cos(0°_{α}). The wave structure of Φ_{δ3}(0)₊ differs fundamentally from that of Φ₂(0°_{α})₊. The objective wave structure propagating in a polarizer is planar. The wave structure retains the longitudinal component of the polarizer-incident wave packet but transversely the wave packet is sharply peaked along the polarizer axis mathematically analogous to that of a Dirac-delta function. Effectively, in the transverse plane the planar wave packet Φ_{δ3}(0°)₊=ξM₃r_{δ}(0°)₊ is objectively represented by the radial vector M₃r_{δ}(0°). Consistent with this representation, the FIG. 4C vector diagram depicts a 0°-oriented vector absent an associated 90° arc. In the context of an objectively real planar wave within a polarizer, Φ and r physically represent vector quantities rather than pie-vectors. Accordingly, to properly identify these Φ_{δ} and r_{δ} as vector quantities, as distinguished from equivalency vectors, these quantities are subscripted with δ.

At the path 2 to path 3 transition point on the input face of calcite 12 is a branch path 3A that represents the path taken by the projection of Φ₂(0°_{α})₊ onto the horizontal polarization axis of calcite 12. The wave amplitude on branch path 3A is secondary to the objective of generating a super-polarized mode however a brief examination of this amplitude is nevertheless instructive in assessing the disposition of all amplitude components. The projection of Φ₂(0°_{α})₊ onto the horizontal polarization axis of calcite 12 results in a planar wave amplitude:

$${Φ}_{δ 3 A} A ( 90 ° ) = ξ t sin ( 0 {°}_{α} ) {r}_{δ} ( 90 ° )$$

that propagates through calcite 12 to the output face where it transitions to a wave packet Φ_{3B} on path 3B. Since the packet arc of Φ₂(0°_{α})₊ does not intersect the horizontal axis of calcite 12, Φ_{δ3A}(90°) and the output Φ_{3B}(90°_{β}) are empty waves, totally depleted of energy quanta.

The total depletion of the output Φ_{3B} is itself an important, novel result of the present configuration's use of energy quanta-bearing input waves linearly polarized in alignment with one axis of a polarizer. The time-averaged wave intensity of the totally depleted output Φ_{3B} is W_{3B}=|Φ_{3B}|²=0.11 calculated from the FIG. 2A distribution relative to wave intensity W₂ of the polarizer incident Φ₂(0°_{α})₊.

The determination that an 11% time-averaged wave intensity can be extracted as a totally depleted wave from an incident wave is a very important result of the “fundamental ensemble projection calculation” briefly summarized here.

The basic polarization ensemble is defined by a cosine squared envelope as shown in FIG. 2A for a 0°-polarized ensemble. That envelope determines the arc bisector distribution of the constituent members. More generally for a ϕ polarized ensemble with a finite number of members given by N the orientation ϕ_{α} of the α member relative to the 0 axis is:

$${ϕ}_{α} = {arccos [ ( α - 1 ) / ( N - 1 ) ]}^{1 / 2} - π / 4 + ϕ$$

in radians.

For the FIG. 2A N=16 member 0°-polarized ensemble the particular depicted example of a member α=2 has a bisector orientation at 0°₂≈30°. For that α=2 ensemble member at 30° from the 0° V axis, a sin 30°=0.5 fraction of the amplitude and, upon squaring, a sin² 30°=0.25 fraction of the wave intensity for that member are projected onto the 90° H axis. A similar calculation is applied to all 16 members. The ensemble-averaged intensity projected onto the H axis is approximately 0.11. A complementary ensemble-averaged intensity of approximately 0.89 is projected onto the V axis. The corresponding average amplitude magnitudes projected onto the H axis and the V axis are respectively (0.11)^{1/2}=0.33 and (0.89)^{1/2}=0.94. An integral solution refines those numerical intensity approximations more precisely to 0.1073 and 0.8927 respectively with corresponding amplitude magnitudes of 0.3276 and 0.9448. These four values constitute the essential results of the “fundamental ensemble projection calculation.”

It may be appreciated that these four values represent “time averages” when applied to a situation involving a large number of linearly polarized modes or discrete photon wave packets sequentially incident in axial alignment with one axis of a two-channel polarizer.

It may be further appreciated that the fundamental ensemble projection calculation also applies to a different temporal situation of a large multiplicity of random ensemble orientation in-phase ensemble modes that are simultaneously present on a single beam. That situation can arise from coherent beam combining, as disclosed in Reference 6,³ which is hereby incorporated by reference in its entirety. ³ T. Y. Fan. “Laser Beam Combining for High-Power. High-Radiance Sources.” IEEE JOURNAL OF SELECTED TOPICS IN QUANTUM ELECTRONICS, Vol. 11. No. 3. My/June: 2005

The utility of extracting 11% of an incident wave's intensity as a totally depleted wave is greatly enhanced if the amplitudes incident on a polarizer are modes of a single longitudinal mode SLM source rather than discrete photons. In the presently considered FIG. 3 configuration, with Φ₂(0°_{α})₊ modes incident on polarizer 12, the output Φ_{3B} then constitutes a coherent totally depleted beam with an average mode intensity that is 11% of the incident quanta-bearing Φ₂(0°_{α})₊ intensity.

The totally depleted output amplitude on path 3B:

$${Φ}_{3 B} ( 90 {°}_{B} ) = ξ {M}_{3 B} r ( 90 {°}_{B} ) = ξ t sin r ( 90 {°}_{B} )$$

showing that its magnitude M_{3B}=t sin(0°_{α}) is unchanged relative to the magnitude M_{3A} of the preceding amplitude Φ_{δ3A}(90°). Notably, when the planar wave amplitude Φ_{δ3A}(90°) reaches the output face of calcite 12, the emergent Φ_{3B}(90°_{β}) is seen to be transversely represented by a random member β of a 90° ensemble. This transition to a random ensemble member is common to unaccompanied (single) planar amplitudes emergent from polarizers.

For the objective of achieving the super polarization depicted in FIG. 3, the amplitudes on paths 4, 5, and 6 must be examined. The amplitude on path 4 is:

$${{Φ}_{4} ( 0 {°}_{α} )}_{+} = ξ r r {( 0 {°}_{α} )}_{+} = ξ {M}_{4} {r ( 0 {°}_{α} )}_{+} .$$

Reflection from mirror 13 does not alter that representation of the amplitude. Φ₄(0°_{α})₊ propagates to a rotator 14 that rotates the amplitude orientation.

Various means are known for rotating the orientation of a mode amplitude by some selected angular span. Rotators for optical range electromagnetic radiation may include half-wave plates (HWPs) and crystalline quartz polarization rotators. Beyond the optical range, other means for providing that rotation are known in the art. In some embodiments of the present disclosure, rotator 14 provides a 90° rotation of the input amplitude. A particular exception to that 90° rotation for a suitable rotator 14 is described below, but even that exception is shown to yield functional equivalence to a 90° rotation. Accordingly, rotator 14 is defined as providing a physical 90° rotation, i.e. an orthogonal rotation, or a rotation that is functionally equivalent to a 90° rotation in the context of generating super-polarized amplitudes.

A specific example of a suitable rotator 14 is presented here for illustration purposes. The example is comprised of a pair of HWPs serving as rotator 14. The first HWP encountered by an incident mode is oriented with its fast axis at 45°. The second HWP, physically separated from the first HWP, is oriented with its fast axis at 90°. The orientations are given relative to a vertical axis defined as 0°.

Alternatively, a polarization rotator such as a crystalline quartz polarization rotator fabricated specifically for 90° rotation can be utilized for rotator 14 to produce the same physical orthogonal rotation accomplished with the pair of HWPs. Rotators of this type are composed of optically active substances that do not require orientation alignment with respect to an input beam's polarization axis unlike the orientation alignment required for HWPs. However, the analysis is the same whether rotator 14 is comprised of a pair of HWPs or a crystalline quartz polarization rotator.

The transit of Φ₄(0°_{α})₊ through rotator 14 rotates that amplitude by +90° resulting in:

$${{Φ}_{5} ( 90 {°}_{α} )}_{+} = ξ r {r ( 90 {°}_{α} )}_{+} = ξ {M}_{5} {r ( 90 {°}_{α} )}_{+}$$

on path 5.

Φ₅(90°_{α})₊ is transversely represented by a random α-member of a 90°-centered ensemble but that particular α is the same as the α-member of the 0°-centered ensemble in Φ₂(0°_{α})₊.

(For example, if 0°_{α}=+30°, then that same α implies that 90°_{α}=120° and the angle between Φ₅(120°)₊ and the H axis is +30° which is the same as the angle between Φ₂(0°_{α})₊ and the 0° V axis.)

In some embodiments, the angle 0°_{α} between Φ₂(0°_{α})₊ and the 0° V axis of calcite 12 is the same as the angle between Φ₅(90°_{α})₊ and the 90° H axis of calcite 12. The respective V and H projection factors of those two amplitudes as they interact with calcite 12 are equal, i.e. cos 0°_{α}=sin 90°_{α}. As a result, the planar wave amplitude:

$${{Φ}_{δ 6} ( 90 ° )}_{+} = ξ {M}_{6} {r}_{δ} {( {90}^{∘} )}_{+} = ξ r sin ( 90 {°}_{α} ) {r}_{δ} {( {90}^{∘} )}_{+} = ξ r cos ( 0 {°}_{α} ) {{r}_{δ} ( 90 ° )}_{+}$$

which differs from

$${{Φ}_{δ 3} ( 0 ° )}_{+} = ξ t cos ( 0 {°}_{α} ) {{r}_{δ} ( 0 ° )}_{+}$$

in amplitude magnitude only by the respective r and t coefficients of the beam splitter.

In the above example where 0°_{α}=30°:

$${{Φ}_{δ 3} ( 0 ° )}_{+} = ξ t cos ( 0 {°}_{α} ) {{r}_{δ} ( 0 ° )}_{+} = ξ t cos ( 30 ° ) {{r}_{δ} ( 0 ° )}_{+} = ξ t 0.866 {{r}_{δ} ( 0 ° )}_{+}$$

$$and$$

$${{Φ}_{δ 6} ( 90 ° )}_{+} = ξ r sin ( 120 ° ) {r}_{δ} {( 90 ° )}_{+} = ξ r cos ( 30 ° ) {r}_{δ} {( 90 ° )}_{+} = ξ r 0.866 {{r}_{δ} ( 90 ° )}_{+} .$$

When the vector sum of the two orthogonal vectors Φ_{δ3}(0°)+Φ_{δ6}(90°)₊ is computed, the orientation of the resultant vector is dependent only on the relative values of t and r associated with the beam splitter and is totally independent of 0° a which in this example is 30°, since the rotation process has equalized the two amplitude coefficients with respect to projection coefficients which otherwise vary according to the orientation of the incident amplitude, leaving only the beam splitter coefficients which are invariant.

Of secondary interest, since the wave packet amplitude Φ₅(90°_{α})₊ intersects the 90° H axis of calcite 12 as shown in FIG. 4E vector diagram, energy quanta on that amplitude transfer onto Φ_{δ6}(90°)₊ as indicated by the ₊ subscript.

The particular exception to the orthogonal, 90° rotation for a suitable rotator 14 noted above is described here. When the second HWP is omitted, the angle between Φ₅₊ and the 90° H axis of calcite 12 is the negative of what it would be when the second HWP is included. This occurs because, in the absence on that second HWP, Φ₄₊ is not rotated by 90° but is instead rotated to an orientation reflected about the H axis relative to that which a 90° rotation would produce. Functionally, with regard to super polarization, the critical projection onto the H axis is the same for the resultant reflected orientation of the state of Φ₅₊, i.e. with one HWP, as it is for the physical orientation of the non-reflected state of Φ₅₊, i.e. with both HWPs or a 90° crystalline quartz polarization rotator.

Continuing with the particular example of 0°_{α}=+30° for the input amplitude mode, the orientation of Φ₅₊ is then 60° and Φ₅₊ is −30° from the H axis of calcite 12 instead of the +30° when both HWPs are used to produce a physical orthogonal, 90° rotation of Φ₄₊. With the single HWP there is a rotation of Φ₄₊ from 30° to 30°₊90°−60°=60° which constitutes a rotation of only 30° where the −60° provides the reflection about the 90° H axis. Then:

$${{Φ}_{δ 6} ( 9 {0}^{∘} )}_{+} = ξ r sin ( {60}^{∘} ) r δ {( 90 ° )}_{+} = ξ r cos ( - 30 ° ) {r}_{δ} {( {90}^{∘} )}_{+} = ξ r 0.866 {{r}_{δ} ( {90}^{∘} )}_{+}$$

which is functionally the same result as that with both HWPs or a 90° crystalline quartz polarization rotator in which there is a 90° rotation of Φ₄₊.

Accordingly, in the particular example of 0°_{α}=+30° the use of a single HWP yields a result that is functionally equivalent to that of a physical orthogonal 90° rotation with both HWPs. This important functional equivalence for a rotator 14 using a single HWP applies for any particular initial input mode of the vertically polarized modes since those modes have orientations of 0°_{α}=−45° to ₊45°. Over that orientation range the projected amplitude when rotator 14 uses one HWP to rotate Φ₄₊ is:

$${{Φ}_{δ 6} ( 90 ° )}_{+} = ξ r cos ( 0 {°}_{α} ) {{r}_{δ} ( 90 ° )}_{+} .$$

This result is functionally equivalent to the physical orthogonal rotation of projected amplitude when rotator 14 uses two HWPs to rotate Φ₄₊:

$${{Φ}_{δ 6} ( 90 ° )}_{+} = ξ r cos ( 0 {°}_{α} ) {{r}_{δ} ( 90 ° )}_{+}$$

since the cosine function is independent of the argument sign over the range −45° to ₊45°.

In some embodiments, rotator 14 provides physical equivalence to an orthogonal rotation of modes input to a rotator comprised of two HWPs or a crystalline quartz polarization rotator fabricated for 90° rotation and, a suitable rotator 14 provides functional equivalence to an orthogonal rotation of modes input to the rotator comprised of one HWP. In some embodiments, rotator 14 provides equivalence to an orthogonal rotation of modes.

In some embodiments, the orientation of any particular input mode may have an unknown orientation θ between −45° to ₊45° with a distribution given by a 0° centered polarization ensemble when the beam providing the modes is polarized along an axis defined 0° axis. In some embodiments, each such mode may be divided into two modes by a conventional beam splitter, a first such mode having the same orientation θ as the input mode from which it was split, and a second such mode also having the same orientation θ as the input mode from which it was split but acquiring a new orientation after passage through rotator 14.

The first mode and the second, rotated mode are directed respectively to a first and a second input of a two-channel polarizer. The polarization axis of the first polarizer input is 0° and the polarization axis of the second polarizer input is an orthogonal 90°. Thereby the amplitude of the first mode is projected along the polarization axis of the first polarizer input with a magnitude proportional to the cosine of the orientation angle θ of the particular input mode.

In some embodiments, rotator 14 may rotate the second mode to an orientation relative to the polarization axis of the second polarizer input such that the amplitude of the second mode is projected along the polarization axis of the second polarizer input with a magnitude proportional to the same factor as that for the first mode. Thereby, the amplitudes of the first and the second modes are proportionately projected onto the polarizer's first and second polarization axes, respectively. That mode and successive modes are recombined in the polarizer and emerge from an output of the polarizer with a common orientation dependent only on the constant values of the r and t coefficients associated with the beam splitter.

It can be appreciated that the constraint of requiring the same factor for both of those axis projections intrinsically requires that the absolute values of the projection angles are the same for both projections. The constraint is satisfied if rotator 14, comprised of a pair of HWPs or a 90° quartz crystalline rotator, produces a rotation that is a physically equivalent orthogonal rotation in which case the projection angles are identical. The constraint is also satisfied if rotator 14, comprised of a single of HWP, produces an orthogonal rotation of the second mode amplitude with respect to the second input polarization axis accompanied by a reflection about that axis in which case the projection angles are equal but opposite in sign and the outcome can be identified as functionally equivalent to an orthogonal rotation.

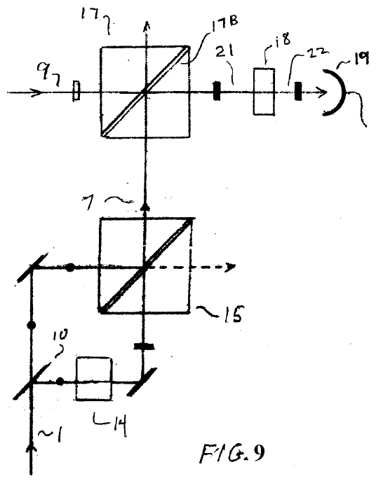

In the above “loop” configuration of FIG. 3, beam paths along the two legs of the loop are effectively equal in the sense that waves traversing the two legs arrive at the loop termination simultaneously. In the optical range, the beam paths are said to be optically equal. This equality is also imposed on related loop configurations in FIG. 5 and FIG. 9.

Of secondary interest, in direct analogy to Φ_{3B}(90°_{β}), the planar amplitude Φ_{δ6A}(0°) on branch path 6A is totally depleted amplitude as is the output amplitude on path 6B:

$${Φ}_{6 B} ( 0 {°}_{Y} ) = ξ {M}_{6 B} r ( 0 {°}_{Y} ) = ξ r sin ( 90 {°}_{α} ) r ( 0 {°}_{Y} ) .$$

Φ_{6B}(0°_{γ}) is transversely represented by a random member γ of the 0° ensemble.

In the foregoing, the amplitudes on paths 3A and 6A in calcite 12 each transition respectively to amplitudes emitted onto output paths 3B and 6B that are each transversely represented as a random member of an ensemble. The amplitudes on output paths 3B and 6B have utility because they are each totally depleted as a result of the respective selected alignments of the amplitudes on paths 2 and 5 with the axes of calcite 12. Nevertheless, the amplitudes on the branched output paths 3B and 6B are not directly participatory in providing super-polarized amplitudes in the FIG. 3 configuration.

In some embodiments of the present disclosure, the amplitudes on paths 3 and 6 in calcite 12 may directly provide the utility of super polarization.

When orthogonal planar amplitudes intersect at the exit face of a two-channel polarizer, the amplitudes combine as a vectorial resultant rather than exiting the polarizer as a random member of a polarization ensemble which is the operant outcome for an unaccompanied planar amplitude exiting a polarizer.

At the output face of calcite 12, the orthogonal vector representations of Φ_{δ3}(0°)₊=ξM₃ r_{δ}(0°)₊ and Φ_{δ6}(90°)₊=ξM_{δ} r_{δ}(90°)₊ intersect where M₃=t cos 0°_{α} and M₆=r cos 0°_{α}. The resultant vector which represents the output amplitude Φ₇(ϕ) is shown on the FIG. 4G vector diagram. The magnitude M of that resultant is:

$${M}_{7} = {( {M}_{3}^{2} + {M}_{6}^{2} )}^{1 / 2} = {( {t}^{2} + {r}^{2} )}^{1 / 2} cos 0 {°}_{α} = cos 0 {°}_{α}$$

since t²+r²=1 for an ideal beam splitter. A non-ideal beam splitter would still be characterized by a similar equation, t²+r²=B²≤1. Nevertheless, non-ideal beam splitters that differ negligibly from ideal beam splitters are widely available and for which B can effectively be treated as unity.

Most importantly, from the perspective of super polarization, the orientation of the path 7 Φ₇(ϕ) is:

$$ϕ = arctan ( {M}_{6} / {M}_{3} ) = arctan [ ( r cos 0 {°}_{α} ) / ( t cos 0 {°}_{α} ) ] = arctan ( r / t ) .$$

Then the orientation ϕ of the output amplitude Φ₇(ϕ) is entirely dependent on the arctangent of the ratio r/t of the amplitude reflection coefficient r and the amplitude transmission coefficient t beam for beam splitter 10. Regardless of the random orientation 0°_{α} of an input mode amplitude Φ₁(0°_{α})₊, the output mode amplitude Φ₇(ϕ) always has a selected orientation ϕ as depicted in the FIG. 2B super-polarized ensemble.

Since Φ₇(ϕ) is formed from the path 3 and path 6 planar amplitudes, Φ_{δ3}(0°)₊ and Φ_{δ6}(90°)₊ respectively, these two planar amplitudes together carry 100% of the irradiance that had been present on the input mode amplitude Φ₁(0°_{α})₊. This is confirmed by observing that the planar amplitudes on the branched paths 3A and 6A, respectively Φ_{δ3A}(90°) and Φ_{δ6A}(0°), are totally depleted. As a result, the super-polarized amplitude Φ₇(ϕ) is more accurately expressed as Φ₇(ϕ)₊ where the irradiance represented by “+” sign is equivalent to that of the input mode amplitude Φ₁(0°_{α})₊. A complete expression of the path 7 super-polarized output amplitude is:

$${{Φ}_{7} ( ϕ )}_{+} = ξ {M}_{7} {r ( ϕ )}_{+} = ξ cos 0 {°}_{α} {r ( arctan r / t )}_{+} .$$

The magnitude M₇=cos 0°_{α} of this amplitude for any individual random input mode Φ₁(0°_{α})₊ is determined by the particular α member that transversely represents that mode since the orientation 0°_{α} of that mode is the basis for M₇=cos 0°_{α}. FIG. 4G depicts the resultant Φ₇(ϕ)₊ vector with an orientation ϕ determined by the magnitudes M₃ and M₆.

A full comparison of the super-polarized output mode amplitude Φ₇(ϕ)₊ relative to the polarized input mode amplitude Φ₁(0°_{α})₊ requires a statistical temporal average of the cos 0°_{α} projections over the 0°_{α} ensemble member orientations of the input modes. That average over the 0°_{α} ensemble member orientations is needed because the orientations of input modes are mutually uncorrelated. In this regard, the random _{α} member associated with one input mode is unrelated to the random α member of another, temporally separate, input mode.

The value of the ensemble average is presented earlier in this section in the fundamental ensemble projection calculation. In that calculation the relevant projected amplitude magnitude is 0.9448 with respect to unit-valued input magnitude. Then for the FIG. 3 super polarizer the time-averaged output amplitude magnitude is:

$$< \vert {Φ}_{7} \vert >= < {M}_{7} > = < cos 0 {°}_{α} >= 0.9448$$

where < > bracketed quantities denote time averaging.

In summary, when a linearly polarized beam of sequentially emitted Φ₁(0°_{α})₊ modes is incident on the super polarization configuration depicted in FIG. 3, the output beam consists of sequentially emitted super-polarized Φ₇(ϕ)₊ modes, all oriented at the same selected orientation ϕ. The super-polarized output beam has 100% of the irradiance of the incident beam while retaining, on average, a 0.8927 fraction of the wave intensity and a 0.9448 fraction of the amplitude magnitude of the incident beam.

It may be appreciated that, based upon the principal wave manipulations conducted to achieve these output results, a configuration such as that depicted in FIG. 3 is appropriately identified as a “split amplitude super polarizer.”

Alternative embodiments of an orthogonal amplitude addition super polarizer can be configured by incorporating the novel features of the FIG. 3 super polarizer but utilizing a two-channel polarizer that is functionally distinct from the calcite polarizer employed in the FIG. 3 embodiment.

Two channel polarizers can be classified into two types with specific regard to their polarization and emission properties. Calcite is an example of a “non-contiguous” type as defined here. It may be appreciated from the foregoing disclosure of the FIG. 3 features that a mode of some orientation θ incident on calcite is divided onto two branched paths with the respective vertical and horizontal projections of the incident mode traveling within the body of the calcite as planar waves on those diverging branched paths. At the exit face of a non-contiguous polarizer such as calcite, an unaccompanied planar wave emits a random member _{α} of an ensemble centered along the polarization axis associated with the path of that planar wave. This emission process would occur for both planar waves on branched paths where neither is accompanied at the exit face of the polarizer.

For example, in FIG. 3, consider planar waves on the branched paths 3 and 3A where path 5 is intentionally blocked thereby ensuring that the planar wave on path 3 is unaccompanied at the exit face of calcite polarizer 12 as is already the case for the planar wave on path 3A. Under these path 5 blocking conditions, amplitudes Φ₇(0°_{α})₊ and Φ_{3B}(90°_{β}) are respectively emitted onto paths 7 and 3B. Respectively, these two output amplitudes are transversely represented as random members σ and β of polarization ensembles centered at 0° and at 90°. In general, σ≠β since the two emission processes at the polarizer exit face are non-local to each other and are therefore uncorrelated with regard to which random member of an ensemble is emitted.

The other type of two-channel polarizer considered here is identified as a “contiguous” type. Two closely related examples of contiguous type polarizers are, most commonly, polarizing beam splitter (PBS) cubes and PBS plates. Both utilize a dielectric layer that separates a beam incident at 45° into orthogonal polarization components. FIG. 5 depicts a super polarizer configuration utilizing a PBS. The FIG. 3 and FIG. 5 super polarizers are functionally closely analogous but exhibit differences attributable to the respective two-channel polarizer types respectively incorporated in those super polarizers.

To emphasize the functional analogs provided by the non-contiguous and the contiguous polarizer types, FIG. 5 retains the same numerical designations as those of FIG. 3 for beam paths that have identical amplitude functions and for equivalent components. Accordingly, Φ₁(0°_{α})₊, Φ₂(0°_{α})₊, Φ₄(0°_{α})₊, Φ₅(90°_{α})₊, and the super-polarized Φ₇(ϕ)₊ respectively on paths 1, 2, 4, 5, and 7 are the same for FIGS. 3 and 5. Moreover, both super polarizing configurations include a beam splitter 10, mirrors 11 and 13, and a rotator 14 each of which also performs the same function in both configurations. In the optical range, the specific example given above of a rotator comprised of a pair of HWPs is similarly applicable to the FIG. 5 configuration.

The FIG. 5 super polarizer differs from FIG. 3 in its use of a “contiguous” type of two-channel polarizer. The particular contiguous polarizer used is a polarizing beam splitter PBS 15 consisting of dielectric layer 15B sandwiched between two transparent prism-like glass substrates 15A and 15C. When vertically polarized Φ₂(0°_{α})₊ is incident at 45° on the dielectric layer 15B, that layer effectively projects the vertical component of the incident Φ₂(0°_{α})₊ onto a reflected path 7. Similarly, when the horizontally polarized Φ₅(90°_{α})₊ is incident at 45° on 15B, the horizontal component of Φ₅(90°_{α})₊ is projected onto a transmitted path that is identical to that same path 7 by positioning mirror 11 such that Φ₂(0°_{α})₊ and Φ₅(90°_{α})₊ intersect at a common point within dielectric layer 15B. The resultant of the reflected vertical component of Φ₂(0°_{α})₊ and the transmitted horizontal component of Φ₅(90°_{α})₊ form a resultant Φ₇(ϕ)₊ that is emitted from dielectric 15B.

Notably, the projection and emission processes are contiguous in the dielectric layer 15B in contrast to these processes being non-contiguous in a polarizer such as the calcite 12 in FIG. 3. Effectively, the contiguous type polarizer in FIG. 5 provides a super-polarized Φ₇(ϕ)₊ without the explicitly propagating intermediaries of the planar wave amplitudes Φ_{δ3}(0°)₊ and Φ_{δ6}(90°)₊ as on paths 3 and 6 respectively in the FIG. 3 non-contiguous type calcite polarizer 12.

Nevertheless, those amplitudes Φ_{δ3}(0°)₊ and Φ_{δ6}(90°)₊ are still functionally operant in the FIG. 5 PBS 15 but are narrowly confined to an interaction volume of dielectric layer 15B defined by the intersection of the two incident beams in that layer. Consequently, the super polarization angle ϕ=arctan(r/t) remains applicable.

The two types of two-channel polarizers necessarily incur different geometrical component configurations, but the two types nevertheless both functionally yield a super-polarized output by a process of orthogonal amplitude addition.

In the interests of completeness, the two types of polarizers do differ with regard to their respective outputs when an incident amplitude is unaccompanied at the exit face of the polarizer. The outcome for this particular circumstance was noted above in the context of the non-contiguous calcite polarizer 12 in FIG. 3. In contrast, the outcome for a contiguous type polarizer can be assessed by similarly intentionally blocking path 5 in the FIG. 5 configuration. That blocking intervention leaves the amplitude Φ₂(0°_{α})₊ on path 2 unaccompanied at the dielectric layer 15B. Φ₂(0°_{α})₊ projects an amplitude Φ₇(0°_{β})₊ onto reflection path 7 and a totally depleted amplitude Φ₈(90°_{β}) onto transmission path 8.

Under these path 5 blocking conditions the orientations of amplitudes Φ₇(0°_{β})₊ and Φ₈(90°_{β}) onto paths 7 and 8 respectively are each transversely represented by random members of a polarization ensemble. However, in the dielectric layer 15B, where polarization projection and emission processes are locally contiguous, path 7 and path 8 amplitude orientations for any input mode can be represented by 0°_{β} and 90°_{β} respectively where β is the same for the 0° centered ensemble and for the 90° centered ensemble signifying that the orientations are correlated. For example, if the random β=2 on a 16-member ensemble, the orientations on path 7 and path 8 would be 30° and 90°+30°=120° respectively.

It should be emphasized that these outcomes of output orientation non-correlation for non-contiguous polarizers and correlation for contiguous polarizers apply only when an amplitude at the exit face of a polarizer is unaccompanied by an intersecting amplitude. These outcomes are examined in the interest of identifying the differences between the two types of polarizers. Accordingly, these outcomes do not apply to normal super polarization operation of the FIGS. 3 and 5 configurations where the input amplitude on path 5 is not blocked and accompaniment occurs in both configurations resulting in a super-polarized Φ₇(ϕ)₊ on path 7.

In summary, the FIG. 3 embodiment using a non-contiguous type two channel polarizer and the FIG. 5 embodiment using a contiguous type two-channel polarizer both constitute split amplitude addition super polarizers despite the differing geometrical configurations of the two embodiments. Similarly, practical applications of super polarizers that incorporate two-channel polarizers, also have functionality for both types of polarizers.

### Polarizer-Retarder Super Polarizer

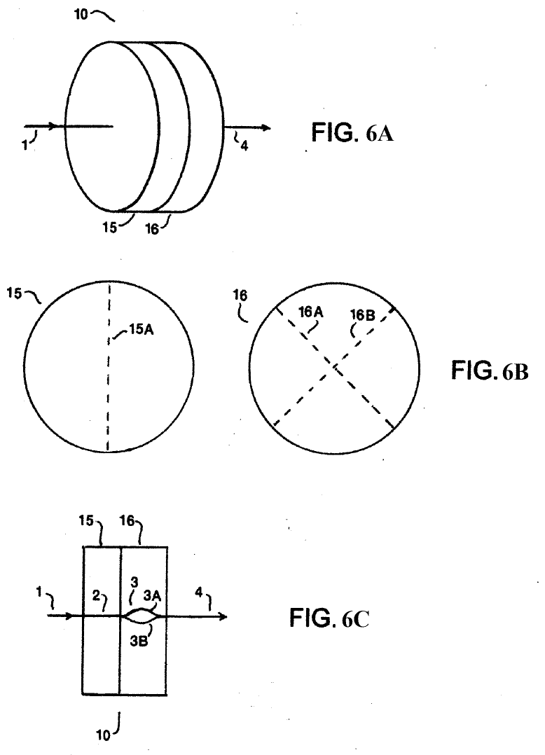

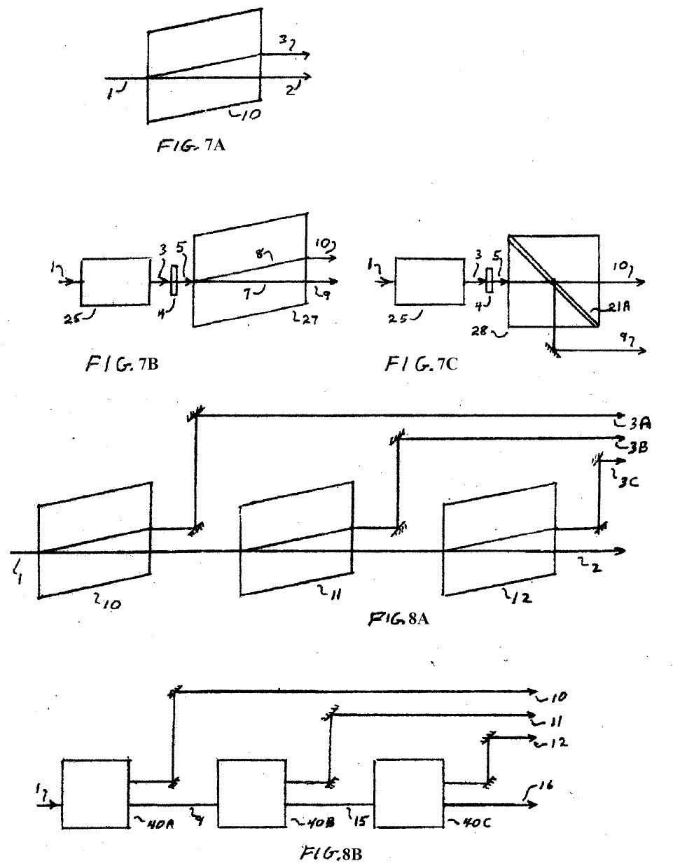

A super polarizer assembly depicted in the FIG. 6A perspective view is functionally related to the FIGS. 3 and 5 split amplitude super polarizing configurations, but achieves super polarization in an assembly that is physically more compact than the configurations shown in FIG. 3 and FIG. 5. For the assembly shown in FIG. 6A, a linearly polarized beam is input on a pair of physically contiguous plates and traverses the plates along a geometrically linear path, emerging as a super-polarized beam. Note that the use of “contiguous” in the present context of a multiplicity of plates is not to be confused with the aforementioned identification of a polarizing beam splitter as a “contiguous” type two-channel polarizer.

As shown in FIG. 6A, a linearly polarized beam 1 is incident on the two-plate assembly 10 that consists of a linear polarizer plate 15 and a retarder plate 16. In the art, the term “retarder plate” is interchangeable with the term “wave plate.” The resultant output beam 4 is super-polarized. FIG. 6B shows incident face plane views of the linear polarizer plate 15 and the retarder plate 16. The dotted line 15A on the FIG. 6B plane view of the polarizer layer 15 depicts the polarization axis of that polarizer, and the two dotted lines 16A and 16B on the plane view FIG. 6B of retarder 16 depict respectively the two polarization axes of that retarder. The input beam 1 is linearly polarized in alignment with the polarization axis 15A of the FIG. 6B polarizer. In a preferred embodiment, retarder 16 is oriented such that its polarization axes 16A and 16B are equiangular from axis 15A of polarizer 15 as depicted in FIG. 6B.

Plate 15 may consist entirely of a linear polarizer substance. A suitable polarizer 15 that provides the requisite plane polarization may be constructed from alternative dichroic compositions such as tourmaline that may be relatively thick and self-supportive, as disclosed in Reference 7,⁴ which is hereby incorporated by reference in its entirety. A suitable polarizer 15 that provides the requisite plane polarization can also be constructed from a birefringent two-channel polarizer such as, in the optical range, calcite by utilizing only one of the two channels. A plate of calcite with faces that are natural cleavage planes will transmit one polarization component of a normally incident unpolarized beam undeflected through the plate. That component is defined in the art as the “ordinary” beam. The orthogonal polarization component of the incident beam is deflected in the calcite by 6.2° and is defined in the art as the “extraordinary” beam. ⁴ Eugene Hecht and Alfred Zajac (1974). Optics. Addison-Wesley Publishing Company. Inc. pp. 227-228.

In the context of the FIG. 6A assembly the polarization axis of the calcite plate associated with the ordinary beam is defined as the vertical polarization axis of the calcite and is assigned an orientation of 0° and the orthogonal axis is defined as the horizontal axis at 90°. If for example the calcite plate is 40 mm thick, the deflected horizontally polarized extraordinary beam will emerge from the plate normal to its surface at a distance of ˜4.3 mm from the undeflected vertically polarized beam. For beams that have Gaussian diameters on the order of ˜1 mm, the two beams are well separated as they emerge from the FIG. 6A assembly allowing the beam deflected within the calcite plate to be blocked and discarded while effectively utilizing only the vertical channel of the two-channel calcite polarizer.

Alternatively, plate 15 may be comprised of a transparent substrate plate onto which a relatively thin linear polarizer layer is bonded. In the optical range of the electromagnetic spectrum, a polarizer may consist of a relatively thin layer or “film” such as oriented polyvinyl alcohol (PVA) that is on the order of ˜0.03 mm in thickness. Such thin materials by themselves are not well suited for incorporation into manufactured systems and accordingly are typically bonded to a supportive transparent substrate that might be on the order of a magnitude or greater in thickness relative to the actual polarizer layer. In other embodiments, a polarizer may be a relatively thin wire-grid comprised of a parallel wire array that is bonded to a supportive substrate as disclosed in Reference 8,⁵ which is hereby incorporated by reference in its entirety. Wire-grid polarizers of suitable wire spacings are functional in the optical range as well as in ranges extending to that of radio waves. In some embodiments, a transparent plate can provide a physical support substrate for a thin layer polarizer and together would comprise plate 15. In that context, the thin layer polarizer face of plate 15 would be contiguous to the plate 16 retarder. ⁵ Eugene Hecht and Alfred Zajac (1974). Optics. Addison-Wesley Publishing Company, Inc. pp. 226-227.

Alternatively, the retarder plate 16 can potentially serve in the role of supportive substrate for thin structures such as PVA film polarizers and wire-grid polarizers thereby obviating the need for a supportive substrate for a thin layer polarizer. That thin layer polarizer would then constitute “plate” 15.

Suitable substances for retarder plate 16 are birefringent. In the optical range, calcite is a well-known birefringent substance but for practical reasons calcite itself is not generally used for retarders because of the excessive precision required in achieving the requisite plate thickness. Nevertheless, there are many alternative materials that exhibit birefringent properties suitable for retarders. Many of these materials such as quartz, mica, and organic polymeric plastics are functional in the optical range while others are functional in longer wavelength ranges. Retarder plates are constructed such that the ordinary and the extraordinary beams generated by a normally incident beam both propagate together collinearly within the retarder, but with different velocities, and emerge as a single output beam still normal to the plate faces. In a retarder plate, that collinearity is associated with an optic axis parallel to the plate faces.

The aforementioned calcite plate used as a polarizer plate 15 could in principle be modified to function as a retarder plate. Instead of utilizing the natural calcite cleavage planes as plate faces, the planes of those faces are both reground at an angle such that the ordinary and the extraordinary beams within the calcite are collinear which renders the optic axis of the calcite parallel to those faces.

For any retarder, the respective axes generating the ordinary and the extraordinary beams can be identified on the input face of the retarder. These axes are depicted respectively by the dotted lines 16A and 16B on retarder 16 in FIG. 6B. The axes correspond respectively to “fast” and “slow” axes or vice versa depending upon the particular molecular composition of the retarder however this distinction is not critical to the present disclosure and it suffices to designate 16A as the fast axis and 16B as the slow axis.

When a linearly polarized wave is normally incident on a retarder plate, the orientation of that mode's amplitude projects onto the retarder plate's two axes. The two amplitude projections, each representing a separate wave, propagate collinearly in the retarder plate as planar waves oriented along those two axes. Because of the differing velocities of the two planar waves, there is a relative phase difference between the two planar waves as they reach the exit face of the retarder where the mutually accompanying modes form a resultant output mode.

There are two phase types of retarder plates 16 applicable to the FIG. 6A super polarizer. These are identified in the art as a half-wave plate (HWP) and a full-wave plate (FWP), in reference to the relative phase shift, λ/2 and λ, respectively produced by these retarder plates. These relative phase shifts ensure that a plane-polarized input mode is output as a plane-polarized mode which is a necessary condition for super polarization. If one of these two relative phase shifts is not accurately achieved by the retarder, the output mode is elliptically polarized.

In the art, a well-known property of the HWP is that it can rotate the orientation of an input mode by a selected rotation of the plate about the propagation axis. This selectable mode rotation capability of HWPs is used to advantage in various configurations in the present disclosure such as in FIGS. 3 and 5 configurations, however for the present FIG. 6A super polarizer configuration, the use of the HWPs confers no critical advantage over the use of FWP's with respect to generating a super-polarized output. The mathematical analysis of the FIG. 6A super polarizer given below in this disclosure is slightly simplified by using the example of a FWP rather than a HWP for retarder plate 16 but that treatment does not imply the exclusion of a HWP in the capacity of retarder plate 16.

Similarly, that mathematical analysis is given for the particular case of the polarizer's axis 15A at a nominal 0° vertical orientation bisecting the retarder's axes 16A and 16B at −45° and +45° respectively as depicted in FIG. 6B. The symmetry of this relative orientation of polarizer 15 and retarder 16 provides additional simplicity and clarity to the mathematical analysis. However, that particular symmetrical relative orientation confers no critical advantage with respect to generating a super-polarized output and arbitrary relative orientations provide also generate super-polarized outputs.

FIG. 6C is a cross sectional view of the polarizer-retarder assembly through the plane inclusive of the beam paths depicted with greatly exaggerated thicknesses of polarizer 15 and retarder 16 for visual clarity. A vertically polarized input beam on path 1 is incident on polarizer 15 and is aligned with its polarization axis 15A. The mathematical representation of the wave function transiting the FIG. 6C plate assembly 10 then resolves to determining wave function transitions on path 2 of the polarizer 15 and path 3 of the contiguous retarder 16.

The objectively real path 1 pie-vector amplitude wave function Φ₁(0°_{α})₊ is represented as an equivalency vector amplitude wave function:

$${{Φ}_{1} ( 0 {°}_{α} )}_{+} = ξ {M}_{1} r {( 0 {°}_{α} )}_{+} = ξ {r ( 0 {°}_{α} )}_{+}$$

for mathematical expediency. Similarly, in this equivalency representation the associated radial unit pie-vector r is represented as a radial unit vector r. The ₊ subscript denotes the presence of energy quanta residing on this path 1 wave structure. The objectively real orientation 0°_{α} is that of a random member α of the 0° polarization ensemble. The input amplitude Φ₁(0°_{α})₊ is normalized to unity, |Φ₁(0°_{α})₊|=1. Correspondingly, |ξ|=|r|=1 and the magnitude coefficient on path 1 is M₁=1.

Φ₁(0°_{α})₊ is incident on polarizer 15 which has its polarization axis 15A oriented along the “vertical” axis at 0°. In the transition process from path 1 to path 2 the wave and the energy quanta are considered separately.

With respect to the wave transition, Φ₁(0°_{α})₊ projects its 0°_{α}-oriented amplitude as a planar wave amplitude:

$${{Φ}_{δ 2} ( 0 ° )}_{+} = ξ cos ( 0 {°}_{α} ) {r}_{δ} {( 0 ° )}_{+} = ξ {M}_{2} {r}_{δ} {( {0}^{∘} )}_{+}$$

propagating along path 2 in polarizer 15 shown in FIG. 6C. The projection introduces a cos(0°_{α}) factor that reduces the amplitude magnitude on path 2 to M₂=cos(0°_{α}). The δ subscript is a reminder that Φ_{δ2}(0°)₊ actually represents an objectively real vector quantity, as opposed to a pie-vector quantity, since the planar wave has an infinitesimal _{δ} arc span vectorially oriented along 0° in the transverse plane. This distinction is noted here primarily as a formality with regard wave structure transitions since the use of equivalency vectors in representation of pie vectors conveniently permits mathematical manipulations entirely within the vector domain regardless of whether the related quantities are objectively real pie-vectors or vectors.

With regard to energy quanta in the path 1 to path 2 transition for FIG. 6C, the critical property of Φ₁(0°_{α})₊, or more precisely Φ₁(0°_{α})₊, is that it is transversely represented by a random member α of a 0°-polarization ensemble. As a result, the associated 90° wave packet arc for any and all a values intersects the “vertical” 0°-oriented polarization axis 15A of the polarizer 15, FIG. 6B. As the projection process proceeds, the energy quanta, which reside on that wave packet arc, are channeled onto the transverse planar wave along 15A as the intersecting wave structure condenses from a 3-dimensional structure to a 2-dimensional structure. Since intersection occurs for any and all a values in the present case, all of the energy quanta on Φ₁(0°_{α})₊ are channeled onto the planar Φ_{δ2}(0°)₊.

Φ_{δ2}(0°)₊ propagates on path 2 to the exit face of the polarizer 15 which critically is physically contiguous to the entrance face of retarder 16. That entrance or incidence face of retarder 16 is depicted in FIG. 6B for a particular choice of axes 16B and 16A at ±45° respectively. In other embodiments, systems and methods of the present disclosure may not be restricted to orienting the retarder axes at ±45°; however, that choice has utility and expedites the mathematical representation given here.

Polarizer 15 and retarder 16 must mutually be in physically contiguous juxtaposition. This criterion is imposed to ensure that Φ_{δ2}(0°)₊ does not enter a sufficient gap between plates 15 and 16 where that amplitude could evolve from a definite vectorially oriented planar wave along 0° to a “gap” state amplitude Φ_{gap}(0°_{β})₊ that has a random orientation 0°_{α} of a 0° polarization ensemble member. Any residual separation between plates 15 and 16 should be minimized to subwavelength dimensions to suppress the evolution of a gap state and to ensure that Φ_{δ2}(0°)₊ deterministically projects its amplitude onto the plate 16 axes.

At the interface of plates 15 and 16, Φ_{δ2}(0°)₊ projects its amplitude equally onto the symmetrically oriented 16A and 16B as the planar wave amplitudes:

$${{Φ}_{δ 3 A} ( - 45 ° , {ρ}_{3 A} )}_{+} = ξ ( {ρ}_{3 A} ) cos ( - 45 ° ) cos ( 0 {°}_{α} ) r δ {( - 45 ° )}_{+}$$

$$and$$

$${{Φ}_{δ 3 B} ( + 45 ° , {ρ}_{3 B} )}_{+} = ξ ( {ρ}_{3 B} ) cos ( + 45 ° ) cos ( 0 {°}_{α} ) r δ {( + 45 ° )}_{+}$$

which propagate as two mutually orthogonal modes on collinear paths 3A and 3B respectively of path 3 in retarder 16 of FIG. 6C. For purposes of clearly distinguishing the two collinear paths 3A and 3B, path 3 is deliberately depicted with constituent paths 3A and 3B split apart. The amplitudes Φ_{δ3A} and Φ_{δ3B} include their respective longitudinal phases ρ_{3A} and ρ_{3B} which also appear in the longitudinal representation of the wave function ξ for those amplitudes. The phases ρ_{3A} and ρ_{3B} are themselves functions of coordinates along the propagation axis. Because the wave velocities on 3A and on 3B are not the same, the respective amplitudes of ξ are in general different at arbitrary points along path 3. In some embodiments, the amplitudes may be evaluated at the extrema points of path 3.

At the beginning of path 3, phases ρ_{3A} and ρ_{3B} are trivially identical. Continuing with the example of 16 as a full wave retarder and axis 16A being the “fast” axis, the phase ρ_{3B} is nominally retarded relative to the phase ρ_{3A} by A, i.e. 360°, at the terminus of path 3 although this retardation may actually be an integer multiple of 360° and the retarder 16 would still qualify as a full wave retarder. In any case, with 16 as a full wave retarder, phases ρ_{3A} and ρ_{3B}, which differed at intermediate points along path 3, are restored to equivalence at the terminus of path 3. At that terminus point ρ_{3A}=ρ_{3B} and ξ(ρ_{3A})=ξ(ρ_{3B}).

These phase considerations permit a simplified representation of the amplitudes specifically at the terminus of path 3 as well as at the beginning of path 3:

$${{Φ}_{δ 3 A} ( - 45 ° )}_{+} = ξ cos ( - 45 ° ) cos ( 0 {°}_{α} ) {{r}_{δ} ( - 45 ° )}_{+} = ξ {M}_{3} {r}_{δ} {( - 45 ° )}_{+}$$

$$and$$

$${{Φ}_{δ 3 B} ( + 45 ° )}_{+} = ξ cos ( 45 ° ) cos ( 0 {°}_{α} ) {{r}_{δ} ( + 45 ° )}_{+} = ξ {M}_{3} {r}_{δ} {( + 45 ° )}_{+}$$

where the amplitude magnitude coefficient

$${M}_{3 A} = {M}_{3 B} = cos ( 45 ° ) cos ( 0 {°}_{α} )$$

is the same for both amplitudes.

This equivalence is not unexpected because of the symmetry between the polarizer 15 axis and retarder 16 axes. As a consequence, the vector resultant of the symmetrically disposed, equal magnitude Φ_{δ3A}(−45°)₊ and Φ_{δ3B}(+45°)₊ is deterministically an output amplitude oriented at 0° on path 4:

$${{Φ}_{4} ( 0 ° )}_{+} = ξ cos ( 0 {°}_{α} ) {r ( 0 ° )}_{+} = ξ {M}_{4} {r ( {0}^{∘} )}_{+}$$

where M₄=cos(0°_{α}).)

Φ₄(0°)₊ is then super-polarized at 0° independent of the particular ensemble member orientation 0°_{α} of the incident amplitude Φ₁(0°_{α})₊.

In some embodiments, the symmetrical choice of ±45° for the retarder 16 axes 16B and 16A depicted in FIG. 6B may provide for a super-polarized output with the same orientation of the plane polarized input ensemble. In some embodiments, the orthogonal axes 16A and 16B can be oriented at 0 and θ+90° where θ is any selected angle. The cosine projection factors introduced onto FIG. 6C path 3A and 3B amplitudes are then generally not equal but the vector resultant of those amplitudes still provides a super-polarized output on path 4 and the orientation of the super-polarized output is a fully determined function of that selected angle.

### Duality Modulation Using Super Polarization

Super polarization has significant utility in providing high efficiency in “duality modulation” DM which is the process of generating energy depleted and enriched beams of electromagnetic radiation from ordinary electromagnetic radiation. The inventors' U.S. patents disclose methods for achieving modest levels of DM using grating-based duality modulation as disclosed in U.S. Pat. Nos. 6,028,686; 6,804,470; 7,262,914; 7,528,380; 8,081,383; 8,670,181; and 9,817,165, which are hereby incorporated by reference in their entireties. Significant improvements to these modest levels of grating-based duality modulators can be achieved by employing polarization-based duality modulators. In that regard, the foregoing analysis of FIG. 3 demonstrates that a beam of linearly polarized single-photons or a linearly polarized SLM input beam, appropriately oriented with respect to a two-channel polarizer, can be used to generate a depleted output beam and an enriched output beam. The FIG. 7A configuration illustrates the performance of these polarization-based duality modulators. A path 1 beam, linearly polarized at 0°, is incident on a polarizer 10. The path 3 output beam is totally depleted with, on average, 11% of the input beam intensity. The path 2 output beam has, on average, 89% of the wave intensity and 100% of the irradiance of the input beam, giving that second output beam an average enrichment of 12%.

The present disclosure shows that very significant improvements to these polarization-based duality modulators can be achieved by first super polarizing an input linearly polarized beam before using a polarizer to generate duality-modulated beams. This combination provides for a single “composite stage” high-efficiency duality modulator, i.e. a super polarization augmented duality modulator.

This improvement can be demonstrated by the configuration shown in FIG. 7B. A 0° linearly polarized single-photon beam or an SLM beam, with magnitude M₁=1, on path 1 is input to a super polarizer shown as a block diagram 25.

The time-averaged magnitude of a super-polarized output amplitude has been shown in this disclosure to reduce the magnitude by a factor of 0.94 relative to the input magnitude. In the present case the super-polarized amplitude Φ₃ has a time-averaged magnitude <M₃>=<|Φ₃|>=0.94. However, that time-averaging does not affect ϕ.

The super-polarized output on path 3 is rotated by HWP 4 to provide a path 5 super-polarized beam with an orientation _{<}45°, if the super polarizer 25 itself is not already configured to produce that _{<}45° orientation in which case HWP 4 can be omitted. In this disclosure, a preceding “<” subscript indicates an orientation is that marginally less than a specified angle which in the present case is 45°. The amplitude Φ₅(_{<}45°)₊=ξ0.94r(_{<}45°)₊ is incident on a two-channel calcite polarizer 27 where the polarizer aligned to transmit vertical and horizontal amplitudes as in FIG. 3.

At an orientation _{<}45°, the 90° wave packet arc of Φ₅ marginally intersects the 0° vertical axis and marginally does not intersect the 90° horizontal axis whereas concurrently the vertical and the horizontal projections of Φ₅(_{<}45°)₊, cos(_{<}45°)≈0.7 and sin(_{<}45°)≈0.7 are both nearly identical. As a result, when the path 5 amplitude Φ₅(−45°)₊ is incident on polarizer 27 in FIG. 7B, the path 7 planar wave amplitude:

$${{Φ}_{δ 7} ( 0 ° )}_{+} = ξ 0.94 cos ( < 45 ° ) {{r}_{δ} ( 0 ° )}_{+} \approx ξ 0.66 {{r}_{δ} ( 0 ° )}_{+}$$

and M₇=0.66. Φ_{δ7} emerges on path 9 from polarizer 27 in FIG. 7B as an output amplitude:

$${{Φ}_{9} ( 0 {°}_{α} )}_{+} = ξ {M}_{9} {r ( 0 {°}_{α} )}_{+} \approx ξ 0.66 {r ( 0 {°}_{α} )}_{+} .$$

The output amplitude Φ₉(0°_{α})₊ has 100% of the irradiance that had been on the super-polarized incident amplitude Φ₅(_{<}45°)₊ that (marginally) intersects the vertical polarization of polarizer 27. The wave intensity W₉ of the output amplitude Φ₉(0°_{α})₊ is:

$${W}_{9} = {\vert {{Φ}_{9} ( 0 {°}_{α} )}_{+} \vert}^{2} = {M}_{9}^{2} = 0.4 4 .$$

Defining the incident amplitude Φ₅(_{<}45°)₊ irradiance as I₅=1, which is the same as the Φ₁ irradiance, the occupation value of the output amplitude Φ₉(0°_{α})₊ is:

$${Ω}_{9} = {I}_{9} / {W}_{9} = 1 / 0.44 = 2.27$$

showing that Φ₉ is enriched by 127% relative to the initial ordinary Φ₁ for which Ω₁=1.

On the branched path 8, the planar wave amplitude:

$${Φ}_{δ 8} ( 90 ° ) = ξ 0.94 sin ( < 45 ° ) {r}_{δ} ( 90 ° ) \approx ξ 0.66 {r}_{δ} ( 90 ° ) .$$

Φ_{δ8} emerges onto path 10 as the totally depleted amplitude:

$${Φ}_{10} ( 90 {°}_{B} ) = ξ {M}_{10} r ( 90 {°}_{B} ) \approx ξ 0.66 r ( 90 {°}_{B} ) .$$

The wave intensity is W₁₀=|Φ₁₀|²=0.66²=0.44 and the irradiance I₁₁=0. The occupation value of this totally depleted amplitude is

$${Ω}_{10} = {I}_{10} / {W}_{10} = 0 / 0.44 = 0.$$

Significantly, the amplitude Φ₁₀ constitutes a totally depleted beam with a relatively high wave intensity that is fully 44% as large as that of the initial amplitude Φ₁.

The advantage of having a relatively high intensity for the totally depleted Φ₁₀ is based on the use of that amplitude as an output signal carrier wave by imposing a conventional modulation on that amplitude. A high initial intensity of Φ₁₀ is essential to the utility of long-distance transmission where ambient attenuation factors may substantially reduce the received intensity. The received irradiance is not reduced in this case since irradiance is already zero when Φ₁₀ is output. However, the utility of a received totally depleted amplitude requires a restoration of irradiance in some proportion to that totally depleted amplitude. That restored irradiance renders the amplitude conventionally detectable so that signal modulations can be demodulated. Consequently, the initial Φ₁₀ intensity must be high enough to ensure that the received, attenuated intensity is adequate to provide an irradiance restoration that accurately can be demodulated against noise levels.

FIG. 7C shows an alternative embodiment of a single “composite stage” high-efficiency duality modulator, functionally equivalent to the configuration shown in FIG. 7B, but employing a contiguous-type polarizing beam splitter in place of a non-contiguous type polarizer such as the calcite depicted in FIG. 7B.

It may be appreciated that the HWP 4 may be eliminated in the configurations shown in FIG. 7B and FIG. 7C by axially rotating the super polarizer 25 to physically achieve the rotation that is otherwise optically achieved by the HWP.

The duality modulator depicted in FIG. 7A represents only a single stage of a polarization-based duality modulator. FIG. 8A depicts a similarly aligned cascade of three such stages that markedly improves performance relative to a single FIG. 7A stage. For example, the FIG. 8A configuration of polarizers 10, 11, and 12 provides a final vertically polarized beam on path 2 with Ω=1.4 which represents a net 40% enrichment for a cascade of three such stages relative to a beam of ordinary input modes on path 1. Concurrently, the cascade provides three totally depleted beams, respectively on paths 3A, 3B, and 3C, which collectively equal 0.30 of the input beam intensity.

Nevertheless, even greater improvements in duality modulator efficiency are achieved by configuring a cascade of composite stages each of which comprises a super polarizer followed by a two-channel polarizer such as those shown in FIGS. 7B and 7C. FIG. 8B depicts a cascade of three such composite stages 40 A, B, and C, each depicted as a block diagram. The final vertical polarization beam output on path 16 provides a wave intensity of W₁₆=(0.445)³=0.088 and irradiance I₁₆=1 giving an Ω₁₆=I/0.088=11.4 with a 1040% enrichment increase relative to an input beam Ω₁=1.

By comparison, the polarization-based three-stage configuration of polarizers shown in FIG. 8A provides a final vertically polarized beam with Ω=1.4 which represents a net a 40% enrichment for a cascade of three such stages. Accordingly, the high-efficiency, super polarization augmented method provides a significant improvement in enrichment for a three-stage cascade. In some embodiments, the improvement in enrichment may be 26-fold.

Concurrently in the configuration shown in FIG. 8B, there are three horizontally polarized totally depleted output beams on paths 10, 11, and 12 respectively associated with the horizontal polarization axes of the two-channel polarizer associated with each respective composite stage. See for example path 10 in comparison to the single stage FIG. 7B or 7C path 10. The intensities on those paths are respectively W₁₀=0.445, W₁₁=(0.445)², and W₁₂=(0.445)³ which collectively add up to 0.73 representing nearly three-quarters of the initial beam intensity extracted as totally depleted, empty waves. By comparison, the arrangement shown in FIG. 8A with a cascade of three polarizer stages, each lacking an accompanying super polarizer, provides three beams 3 A, B, and C that collectively have 0.30 of the unit input beam intensity. The composite three-stage cascade augmented by super polarization, shown in FIG. 8B, provides a 2.4-fold improvement in intensity extraction relative to that of the FIG. 8A cascade comprised of three polarizer stages. Additionally, unlike the FIG. 8A totally depleted output beams, the FIG. 8B totally depleted beams have relative phase relations that enable those separate beams to be efficiently combined into a single high-intensity totally depleted beam. The FIG. 8A totally depleted output beams are in phase with each other aside from a random additional 180° phase factor for any individual beam. Consequently, as the multiplicity of such beams increases, their mutual amplitude summation converges to zero which restricts the utility of those beams to applications in which the beam amplitudes are not combined.

### Super Polarizer Switch

FIG. 9 depicts a “super polarizer switch” that incorporates a super polarizer to sensitively detect a relatively low-intensity empty wave signal beam. That empty wave signal beam, received on path 9, is extracted by a polarizer from a beam of single longitudinal coherent modes, an SLM beam, defined as vertically polarized, that is conventionally encoded with binary wave intensity modulations. After extraction by the polarizer the signal beam on path 9 is optimally a horizontally polarized empty beam as indicated by the non-solid bar.

The conventionally encoded binary wave intensity modulations consist of pulses of many wavelengths over some time interval _{Δ}t, during which a uniform signal beam intensity represents a “digital 1” and a negligible signal beam wave intensity represents a “digital 0.”

The received empty wave signal beam on path 9 is of the same wavelength as that of a “provided” super-polarized SLM beam on path 7. Optimally, the signal beam on path 9 is linearly polarized but the super polarizer switch depicted in FIG. 9 still maintains substantial functionality if the path 9 beam is unpolarized.

Most generally, it may be appreciated that the FIG. 9 configuration is an analog to a transistor with its three terminals that operates with electromagnetic waves rather than with electrical currents. In this regard the FIG. 9 configuration beam paths 1, 9 and 22 function as three terminals in analogy to a transistor.

In further analogy to a transistor, the FIG. 9 configuration is most relevant to a transistor such as a field effect transistor (FET) acting as a switch rather than as an amplifier. The configuration shown in FIG. 9 is designed to be in a bias state with no irradiance output onto path 22 when a negligible-intensity digital 0 pulse signal is received on path 9. Conversely, when a digital 1 pulse signal at a threshold level or greater is received on path 9, a substantial irradiance beam is present on path 22 and is measured by detector 19. That substantial irradiance beam on path 22 is fixed in magnitude for all path 9 input signal intensities that consequentially exceed the threshold level determined by the bias state of the configuration. In this regard the FIG. 9 configuration operates as a switch, alternately transmitting or blocking the substantial irradiance beam in accordance with the binary signal modulations.

In analogy to a transistor switch, it can be appreciated that the super polarizer switch still functions as an amplifier in the sense that during a digital 1 pulse the zero irradiance of the input signal beam on path 9 is amplified non-proportionally to some substantial irradiance on the path 22 output.

FIG. 9 shows a super polarizer switch that functions by using the received empty signal beam 9 to control the propagation of the super-polarized irradiance-bearing beam 7 through the linear polarizer 23 that immediately precedes detector 25. The super polarizer in FIG. 9 consists of the path 1 to path 7 configuration as shown in FIG. 5 which uses a “contiguous” two-channel polarizer such as the depicted PBS or the functionally equivalent FIG. 3 which uses a “non-contiguous” two-channel polarizer such as calcite. Similarly, the PBS contiguous two-channel polarizer 15 depicted in FIG. 9 can be functionally replaced with a non-contiguous two-channel polarizer such as calcite.

For functionality, the super-polarized beam 7 is set to an orientation marginally less than 45°, symbolically notated in this disclosure as “_{<}45°” by a selection of an r/t ratio marginally less than unity for beam splitter 10. As a result, beam 7 coherence lengths marginally have the orientation of a member of a vertically polarized ensemble. It may be appreciated that the orientation of the super-polarized beam is marginally orthogonal to the polarization of the received beam.

In the preferred embodiment of the super polarizer switch the source beams for 7 and 9 are both CW SLM rather than single-photon emitters since, as a practical matter, it is very difficult to provide sufficient temporal coincidence of single-photon wave packets when their respective sources are independent. Temporal coincidence would be needed at the dielectric layer 17B in order that a _{<}45° super-polarized occupied photon wave packet arrives in substantial overlap with a horizontally polarized empty photon wave packet to ensure that the typical resultant elliptically polarized occupied photon wave has some significant probability of having a long axis _{>}45° and of being transmitted by polarizer 18. Repeatedly achieving these criteria for independently emitted single-photons is problematic.

However, when the sources for beams on paths 7 and 9 are both CW SLM, both beams are always concurrently present at dielectric layer 17B, provided that the beam on path 9 is not in a zero-intensity state. The typical resultant is a highly elliptically polarized beam when the path 7 beam intensity substantially exceeds the empty wave beam non-zero intensity on path 9. Although the path 9 amplitude contribution is small, it is still typically sufficient to cause the long axis of the resultant ellipse to be incrementally rotated from the _{<}45° of the super-polarized orientation of the irradiance-bearing beam on path 7. In that process the ellipse reaches a _{>}45° orientation of its long axis whereupon a substantial fraction of the irradiance on the resultant path 21 beam is transmitted by linear polarizer 18 to conventional detector 19. This outcome occurs very approximately half of the time for a random relation phase condition between the instantaneous coherence lengths of the path 7 and 9 beam. For the other half of the time, an opposite rotation renders the resultant beam on path 21 substantially untransmissible by polarizer 18. Nevertheless, if digital pulse lengths are inclusive of multiple coherence lengths, e.g. ten such lengths, then reliably 50% of the irradiance on path 7 is received by detector 19 during a digital 1.

Conversely, if the received empty signal beam on path 9 is at a digital 0 pulse or is simply absent, the occupied super-polarized beam on path 7 is reflected by dielectric layer 17B in PBS 17 onto beam path 21 as an occupied vertically polarized beam that encounters a horizontally oriented linear polarizer 18. Because the occupied beam on path 21 is vertically polarized, that beam is absorbed by linear polarizer 18 and no irradiance reaches beam path 22 and conventional detector 19.

Then, advantageously, the FIG. 9 super polarizer switch very sensitively decodes low intensity path 9 empty wave digital pulses with relatively high intensity, irradiance-bearing waves on path 7.

For the purposes of familiarity, many of the examples of the present disclosure have been presented in the context of the optical range of the electromagnetic spectrum. However, the scope of the present disclosure is not restricted to that range and extends broadly over the electromagnetic spectrum, most notably to the microwave range. In that regard, there are suitable alternatives in non-optical ranges for critical components of the present disclosure such as coherent sources and polarizers. These alternatives have been noted in the present disclosure and in prior disclosures of the inventors.

What is claimed is:

1. A system for generating super-polarized electromagnetic radiation longitudinal modes, comprising:
a source providing a source beam of electromagnetic radiation, wherein the source beam comprises a linearly polarized single longitudinal mode beam and has a selected polarization axis;
a beam splitter having a selected transmission-reflection coefficient ratio for dividing the source beam into a first beam comprising the selected polarization axis and a second beam comprising the selected polarization axis;
a rotator that provides equivalence to an orthogonal rotation of modes;
a two-channel polarizer having a first input with a first input polarization axis and a second input with a second input polarization axis orthogonal to the first input polarization axis; and
a means for directing the first beam from the beam splitter to the first input of the two-channel polarizer and directing the second beam from the beam splitter to the second input of the two-channel polarizer;
wherein the selected first beam polarization axis of the first beam is in axial alignment with the first input polarization axis of the two-channel polarizer and orthogonal to the second input polarization axis of the polarizer;
wherein the rotator is positioned in a path of the second beam having an axial orientation to provide equivalence to an orthogonal rotation of modes on the second beam;
wherein a first path traveled by the first beam from the beam splitter to an output of the system is equal in length to a second path traveled by the second beam from the beam splitter to the output of the system; and
wherein the first beam and the second beam combine at the output of the system to form an output beam including super-polarized modes having an output orientation determined by the selected transmission-reflection coefficient ratio of the beam splitter.

2. The system of claim 1, wherein the source beam of electromagnetic radiation comprises single-photon wave packets, wherein the output beam comprises super-polarized single-photon wave packets determined by the selected transmission-reflection intensity ratio of the beam splitter.

3. The system of claim 1, wherein the source beam of electromagnetic radiation is coherent, wherein the output beam comprises super-polarized coherent modes determined by the selected transmission-reflection intensity ratio of the beam splitter.

4. The system of claim 1, wherein the polarizer is one of a contiguous type two-channel polarizer and a non-contiguous type two-channel polarizer.

5. A method for generating a super-polarized beam of electromagnetic radiation having a specified polarization axis, the method comprising
providing a source beam comprising a plurality of single linearly polarized electromagnetic radiation modes comprising a selected polarization axis, and
splitting, using a beam splitter having transmission-reflectance coefficients comprising a selected ratio, the source beam into a first beam comprising the selected polarization axis and a second beam comprising the selected polarization axis;
directing the first beam from the beam splitter to a first input of a two-channel polarizer, wherein the selected polarization axis of the first beam is aligned with a first input polarization axis of the first input;
rotating the second beam using a rotator that provides equivalence to an orthogonal rotation of modes such that an orientation of the rotated second beam is aligned with a second polarization axis of the second input of the two-channel polarizer;
directing the rotated second beam from the beam splitter to a second input of the two-channel polarizer wherein the second input polarization axis of the second input is orthogonal to the first input polarization axis of the first input; and
combining the first polarized beam with the rotated and polarized second beam at an output to form an output beam including super-polarized modes having an output orientation determined by the selected transmission-reflection coefficient ratio of the beam splitter;
wherein a first path traveled by the first beam from the beam splitter to a beam output is equal in length to a second path traveled by the second beam from the beam splitter to the output; and
wherein, for all input linearly polarized modes, the selected ratio of transmission-reflectance coefficients of the beam splitter results in a common orientation for all modes on the output beam.

6. The method of claim 5, wherein the source beam comprises single photon wave packet modes.

7. The method of claim 5, wherein the source beam comprises single coherent longitudinal modes.

8. The method of claim 5, wherein the polarizer is one of a contiguous type two-channel polarizer and a non-contiguous type two-channel polarizer.

9. A system for generating a super-polarized beam of electromagnetic radiation having longitudinal modes, comprising:
a source providing a source beam of electromagnetic radiation comprising longitudinal modes, the source beam having a source beam polarization axis;
a single-channel plate polarizer for receiving the source beam from the source having a polarizer plate polarization axis creating a polarized beam;
a retarder plate for receiving the polarized beam from the single-channel plate polarizer, the retarder plate having two polarization axes, wherein the retarder plate is one of a halfwave retarder plate and an integer multiple halfwave retarder plate for creating an output beam;
wherein the polarizer plate and the retarder plate are in contiguous juxtaposition;
wherein the source beam polarization axis is aligned with the polarizer plate polarization axis;
wherein the two polarization axes of the retarder plate are bisected by the polarizer plate polarization axis; and
wherein the output beam is a super-polarized beam of longitudinal modes.

10. The system of claim 9, wherein the source beam comprises longitudinal modes of single-photon wave packets, whereby the output beam comprises super-polarized single-photon wave packet longitudinal modes.

11. The system of claim 9, wherein the source beam comprises coherent modes, and wherein the output beam comprises super-polarized coherent longitudinal modes.

12. A method for re-orienting linearly polarized electromagnetic radiation modes present on an input beam, having a specified polarization axis, to a selected common orientation on an output beam, said method comprising:
providing a source beam comprising linearly polarized electromagnetic radiation modes;
transmitting the source beam through a linear polarizer plate, wherein a polarization axis of the source beam is aligned with a polarization axis of the linear polarizer plate;
generating an output beam comprising longitudinal modes at a selected orientation by passing the transmitted source beam through a retarder plate having two polarization axes, wherein the retarder plate is one of a halfwave retarder plate and an integer multiple halfwave retarder plate for creating an output beam, wherein the linear polarizer and the retarder are in contiguous juxtaposition such that the two polarization axes of the retarder are bisected by the polarization axis of the polarizer.

13. The method of claim 12, wherein the longitudinal modes of the source beam are single-photon wave packet longitudinal modes and wherein the output beam comprises photon wave packet longitudinal modes at a selected common orientation.

14. The method of claim 12, wherein the longitudinal modes of the source beam are coherent longitudinal modes; and wherein the output beam of comprises coherent longitudinal modes at a selected common orientation.

15. The system of claim 1, further comprising:
a two-channel polarizer with an input for receiving the output beam including a first channel having a first polarization axis and a second channel having a second polarization axis orthogonal to the first polarization axis; and
a first output having a first output polarization axis and a second output having a second output polarization axis,
wherein the means providing a super polarized beam is set to transmit all of an irradiance on the super polarized beam through the first output and exclude transmission of the irradiance through the second output; and
wherein the first output provides an enriched beam that includes a duality modulation occupation value omega that is increased substantially by a factor of two relative to that of the incident super polarized beam and concurrently the second output of the polarizer provides a beam that is totally depleted, empty, and has substantially half of the wave intensity relative to that of the incident super polarized beam.

16. The system of claim 15, further comprising:
a plurality of stages wherein each stage comprises a generator of duality modulated electromagnetic radiation having an input and two outputs, an enriched beam output, and an empty wave beam output; and
wherein a beam of single linearly polarized longitudinal modes is provided to the input of a first such stage and, for subsequent stages, the enriched beam output of the previous stage is provided to each subsequent stage in place of the beam of single linearly polarized longitudinal modes provided to the first stage; and
whereby the final stage provides an enriched output beam that has a duality modulation occupation value omega that is increased substantially by a factor of two times the multiplicity of cascade stages relative to that of the incident super polarized beam; and
whereby the empty wave output from each successive stage provides an empty wave intensity that is substantially half the wave intensity of the wave entering the input of that stage.

17. The system of claim 9, further comprising:
a two-channel polarizer with an input for receiving the output beam including a first channel having a first polarization axis and a second channel having a second polarization axis orthogonal to the first polarization axis; and
a first output having a first output polarization axis and a second output having a second output polarization axis,
wherein the means providing a super polarized beam is set to transmit all of an irradiance on the super polarized beam through the first output and exclude transmission of the irradiance through the second output; and
wherein the first output provides an enriched beam that includes a duality modulation occupation value omega that is increased substantially by a factor of two relative to that of the incident super polarized beam and concurrently the second output of the polarizer provides a beam that is totally depleted, empty, and has substantially half of the wave intensity relative to that of the incident super polarized beam.

18. The system of claim 17, further comprising:
a plurality of stages having an input and two outputs, an enriched beam output, and an empty wave beam output; and
wherein a beam of single linearly polarized longitudinal modes is provided to the input of a first such stage and, for subsequent stages, the enriched beam output of the previous stage is provided to each subsequent stage in place of the beam of single linearly polarized longitudinal modes provided to the first stage; and
whereby the final stage provides an enriched output beam that has a duality modulation occupation value omega that is increased substantially by a factor of two times the multiplicity of cascade stages relative to that of the incident super polarized beam; and
whereby the empty wave output from each successive stage provides an empty wave intensity that is substantially half the wave intensity of the wave entering the input of that stage.

19. The system of claim 1, further comprising:
a two-channel polarizer having two inputs and at least one output, the two-channel polarizer configured to receive an empty beam comprising empty linearly polarized coherent modes and configured to receive the output beam, wherein the empty beam has the same wavelength as the output beam, and wherein the output beam has a polarization orientation marginally orthogonal to the polarization orientation of the empty beam;
wherein the polarization orientation of the empty beam is aligned with a polarization axis of the receiving channel; and
the output beam is received by the other channel of the two-channel polarizer;
wherein the empty beam and the output beam are combined using the two-channel polarizer forming an irradiance-bearing beam from an output of the two-channel polarizer; and
a linear polarizer aligned with the polarization orientation of the empty beam,
a detector for receiving the irradiance-bearing beam from an output of the two-channel polarizer;
whereby when the received empty beam pulse has a non-zero intensity, the linear polarizer transmits on average a substantial fraction of the irradiance-bearing output beam to the detector; and
whereby when the received empty beam pulse has a zero intensity, the linear polarizer does not transmit the irradiance-bearing output beam to the detector.

20. The system of claim 9, further comprising:
a two-channel polarizer having two inputs and at least one output, the two-channel polarizer configured to receive an empty beam comprising empty linearly polarized coherent modes and configured to receive the output beam, wherein the empty beam has the same wavelength as the output beam, and wherein the output beam has a polarization orientation marginally orthogonal to the polarization orientation of the empty beam;
wherein the polarization orientation of the empty beam is aligned with a polarization axis of the receiving channel; and
the output beam is received by the other channel of the two-channel polarizer;
wherein the empty beam and the output beam are combined using the two-channel polarizer forming an irradiance-bearing beam from an output of the two-channel polarizer; and
a linear polarizer aligned with the polarization orientation of the empty beam,
a detector for receiving the irradiance-bearing beam from an output of the two-channel polarizer;
whereby when the received empty beam pulse has a non-zero intensity, the linear polarizer transmits on average a substantial fraction of the irradiance-bearing output beam to the detector; and
whereby when the received empty beam pulse has a zero intensity, the linear polarizer does not transmit the irradiance-bearing output beam to the detector.
